(19) United States
(12) Patent Application Publication
(10) Pub. No.: US 2005/0120055 A1
(43) Pub. Date: Jun. 2, 2005

(54) Image management apparatus and image managing method

(75) Inventor: Katsuhisa Kawaguchi, Kanagawa (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 10/992,995

(22) Filed: Nov. 19, 2004

(30) Foreign Application Priority Data
Nov. 27, 2003 (JP) 2003-398017
Nov. 27, 2003 (JP) 2003-398018
Nov. 27, 2003 (JP) 2003-398019

(51) Int. Cl. G06F 7/00

(52) U.S. Cl. 707/104.1

(57) ABSTRACT

An apparatus includes: a information file generation unit generating a information file indicating the dependence between an image file and a group to which the image file belongs; an image file selection unit selecting an image file; an information input unit inputting related information to be displayed with a reproduced image when the selected image file is reproduced; an image file generation unit generating an image file with related information for use in reproducing the related information together with the selected image file; and a group selection unit selecting a group to which the image file with related information belongs. The information file generation unit generates designation information for designation of the dependence between the image file with related information and the selected group, and the designation information is stored in the information file such that the image file with related information can be reproduced in a predetermined order.

### CROSS REFERENCE TO RELATED APPLICATIONS

This application claims benefit of Japanese Applications No. 2003-398017, filed No. 27, 2003; No. 2003-398018, filed Nov. 27, 2003; and No. 2003-398019, filed Nov. 27, 2003, the contents of which are incorporated by this reference.

### BACKGROUND OF THE INVENTION

1. Field of the Invention

The present invention relates to the technology of managing an image, and more specifically to the technology of managing an image for each group.

2. Description of the Related Art

There is album software for sorting and managing a large number of images taken and stored in a digital camera (hereinafter referred to simply as a “camera”) by, for example, shooting date, shooting place, event such as an athletic meeting, a trip, etc. Since the conventional album software has been used on a personal computer mounted in each user home, etc., the functions provided by album software such as generating an album, adding and deleting an image to and from an album, switching an image to another album, browsing an album, etc. have been performed only in the home of each user. In this situation, to satisfy a request from users to browse an album on the spot where an image is taken or on a trip without a personal computer at hand, a camera loaded with an album function has been marketed these days.

The method of image data management using a camera loaded with an album function if described below by referring to FIGS. 1A and 1B.

FIGS. 1A and 1B show the structure of the management of an image data file on a record medium such as a memory card, etc. for storing image data in a camera. FIG. 1A shows an example of managing duplicated image data files. FIG. 1B shows an example of managing images using an image list file.

In the folder structure shown in FIG. 1A, an image root folder DCIM and an album root folder ALBUM are arranged immediately below the root directory.

An image root folder is a root folder for storing an image data file, and stores immediately below in the folder a 100 OLYMP folder as an image storage folder. In FIG. 1A, the 100 OLYMP folder stores an image data file about an image taken by a camera. That is, in FIG. 1A, image data files such as 001. JPG, 002. JPG, 003. JPG, etc. are stored in the in the 100 OLYMP folder.

On the other hand, an album root folder is a root folder for storing an image data file included in an album, and the folder stores an album folder such as an ALBUM 1, ALBUM 2, . . . , etc. In FIG. 1A, the album folder named ALBUM 1 stores image data files such as XXX. JPG, 003. JPG, YYY. JPG, . . . , etc. With this folder structure, it is indicated that the images represented in the image data files belong to (contained in) the album “ALBUM 1”.

In FIG. 1A, the image data file 003. JPG marked with an arrow is stored in both image root folder and album root folder. That is, since the record medium stores two image data files having the same data contents, the record area is wasted. In a camera, it is not desired that the wasteful use of a record area reduces the possible number of pictures taken by the camera. Furthermore, the consumption of a record area further increases when the same image data file belongs to a plurality of albums.

On the other hand, with the folder structure shown in FIG. 1B, the image root folder DCIM and the album list file ALBUM. PVM are stored immediately below the root folder.

The image root folder shown in FIG. 1B is also a root folder for an image data file as in FIG. 1A, and stores a folder named 100 OLYMP folder as an image storage folder immediately below the root folder. However, in FIG. 1B, an image data file about an image taken by the camera is stored in the 100 OLYMP folder, and also an image data file contained in an album is stored. In FIG. 1B, image data files such as 001. JPG, 002. JPG, 003. JPG, . . . , XXX. JPG, YYY. JPG, . . . , etc. are stored in the 100 OLYMP folder.

The album list file is related information file indicating the relationship between the image data file stored in the image root folder and the album to which the image data file belongs (which contains the image data file). The image list file has the data structure in which the file names of the image data file belonging to each album are arranged for each album as shown in FIG. 1B, and the arrangement of the file names for each album indicates the dependence between an image data file and an album. Depending on the data example of the ALBUM. PVM shown in FIG. 1B, for example, the image data file belonging to the album called “ALBUM 1” is XXX. JPG, 003. JPG, YYY. JPG, . . . , etc. The relationship between the image data file and the album is shown in FIG. 1B as well as in FIG. 1A. In the data example of ALBUM. PVM shown in FIG. 1B, the information indicating the folder storing an image data file (100 OLYMP) is omitted.

By adopting the method of indicating the dependence between an image data file and an album using the image list file as shown in FIG. 1B, the wasteful consumption of a record area by storing a plurality of the same image data files in a record medium as shown in FIG. 1A can be eliminated. Therefore, the record medium of a camera having a strict restriction of record capacity can be efficiently used.

The method of managing an album using an image list file is also proposed by the music photo video (MPV) standard developed by the Optical Storage Technology Association (OSTA) which is a standard organization of an optical storage.

Another technology, for example, Japanese Patent Laid-open Publication No. Hei 11-224266 discloses the technology of easily grasping the entire flow of pictures by arranging and listing images selected under a predetermined condition from among index images extracted from a series of images (moving pictures) based on an analysis of the series of images in time order as a series of representative images, recognizing a telop as indicating the title of a television program, etc. when the telop is displayed in the center of the representative images, and displaying the image as the cover of a book, thus automatically generating a book-type electronic image document.

Additionally, for example, Japanese Patent Laid-open Publication No. Hei 9-73530 discloses the technology of automatically selecting an image of a white page in document images stored in an MO medium in an image filing apparatus for filing an image at an instruction to perform deletion of a white page by an operator, and deleting the selected image from the MO medium.

Furthermore, for example, Japanese Patent Laid-open Publication No. 2003-196077 discloses the technology of removing all images from the record medium excluding protected images when, in the print system having a digital camera and a printer, a setting for protection can be placed on each image stored in a record medium, and an instruction to remove all images is issued to this print system.

### SUMMARY OF THE INVENTION

The image management apparatus which is one of the aspects of the present invention includes: a dependence information file generation unit generating a dependence information file indicating dependence between an image data file and a group to which the image data file belongs; an image data file selection unit selecting an image data file; an information input unit inputting related information to be displayed with a reproduced image when the selected image data file is reproduced; an image data file generation unit generating an image data file with related information for use in reproducing the related information together with the selected image data file; and a group selection unit selecting a group to which the image data file with related information belongs. The dependence information file generation unit generates image designation information for designation of the dependence between the image data file with related information and the selected group, and the image designation information is stored in the dependence information file such that the image data file with related information can be reproduced in a predetermined order.

The image managing method is another aspect of the present invention includes: obtaining an instruction to select a file group of the image data files which stores at least one image data file; obtaining an instruction to select an image data file for association with the selected file group; obtaining the input of the related information for reproduction and display with the selected image data file; generating a representative image data file to combine the related information and the selected image data file together; and associating the generated representative image data file with the selected file group, and regulating the reproduction priority in reproducing the selected file group.

The image display device which is a further aspect of the present invention includes: an image data file storage unit storing a representative image data file which is generated by combining an image data file and a related information for reproduction and display with the image data file and for which a reproduction priority for use in reproduction and display is regulated; a file group selection unit selecting a file group to be reproduced and displayed from a file group including at least one image data file; and a reproduction and display unit reproducing and displaying a representative image data file associated with the selected file group in the reproduction priority.

Another aspect of the image management apparatus includes: a record unit storing a plurality of image data files; a dependence information storage unit storing dependence information indicating the dependence between an image data file recorded in the record unit and a group to which the image data file belongs; a dependence dismissal unit dismissing the dependence indicated by designated dependence information by changing the dependence information relating to predetermined image data file described in the designate dependence information in the dependence information storage unit when there is an instruction to delete a predetermined image data file belonging to a predetermined group; and a data file deletion unit deleting the predetermined image data file from the record unit when the dependence between the predetermined image data file and any group is dismissed by the dependence dismissal unit.

In an image managing method according to another aspect of the present invention includes: dismissing a dependence indicated by designated dependence information by changing the dependence information, which indicates the dependence between image data files recorded in a record unit and a group to which each of the image data files belongs, and which relates to a predetermined image data file when there is an instruction to delete the predetermined group; and deleting the predetermined image data file from the record unit when the dependence between the predetermined image data file and any group is dismissed.

The image management apparatus according to a further aspect of the present invention includes: a dependence information storage unit storing dependence information indicating the dependence between an image data file and a group to which the image data file belongs; a deletion target file information generation unit comparing specified dependence information indicating the dependence information about a specified group in the dependence information stored in the dependence information storage unit with other dependence information and generating deletion target file information which is the information designating an image data file not belonging to a group other than the specified group in the image data files belonging to the specified group when an instruction to collectively delete image data files belonging to the specified group is received; an image data file deletion unit deleting all image data files designated by the generated deletion target file information from a record unit recording the image data file; and a dependence dismissal unit dismissing all dependence about the specified group indicated by the specified dependence information by changing the dependence information when the instruction to collectively delete the image data files is received.

In an image managing method according to another aspect of the present invention includes: comparing specified dependence information indicating a dependence information about a specified group in the dependence information, which indicates the dependence between an image data file and a group to which the image data file belongs, with other dependence information when an instruction to collectively delete image data files belonging to the specified group is received, and generating deletion target file information designating an image data file not belonging to a group other than the specified group in the image data files belonging to the specified group; deleting all image data files designated by the generated deletion target file information from a record unit recording the image data file; and dismissing all dependence about the specified group indicated by the specified dependence information by changing the dependence information when the instruction to collectively delete image data files is received.

The image management apparatus according to another aspect of the present invention includes: image memory storing a plurality of image data files; a first control file describing dependence information for a first image data file selected from the image memory; a second control file describing dependence information for a second image data file selected from the image memory; an image data file deletion unit designating a control data file commonly registered in the first and the second control file when an instruction to collectively delete the contents of the first control file is issued, and further designating a control data file other than the designated common control data file from the first control file, and deleting an image data file corresponding to the designated control data file from the image memory; and a control data file deletion unit collectively deleting all control data files stored in the first control file when the instruction to collectively delete the contents of the first control file is issued.

### BRIEF DESCRIPTION OF THE DRAWINGS

The present invention will be more apparent from the following detailed description when the accompanying drawings are referenced.

FIG. 1A shows the first example of image data management with a camera loaded with an album function;

FIG. 1B shows the second example of image data management with a camera loaded with an album function;

FIG. 2 shows the outline of an embodiment of the album function;

FIG. 3A shows the configuration of the hardware of a camera shown in FIG. 2;

FIG. 3B shows the configuration of the hardware of the PC shown in FIG. 2;

FIG. 4 is a flowchart of the contents of the taken image obtaining process;

FIG. 5A is a flowchart (1) showing the process of the album manipulating process;

FIG. 5B is a flowchart (2) showing the process of the album manipulating process;

FIG. 6 shows an example of the album manipulation screen;

FIG. 7 is a flowchart of the contents of the cover image generating process;

FIG. 8 shows an example of the cover image generation screen;

FIG. 9 is a flowchart showing the contents of the title composing process;

FIG. 10 shows an example of the title input screen;

FIG. 11 is a flowchart of the contents of the album transfer process;

FIG. 12 is a flowchart of the contents of the album receiving process;

FIG. 13 is a flowchart of the contents of the album browsing process;

FIG. 14A shows an example of the album manipulation function selection screen;

FIG. 14B shows an example of the listing screen of the album cover image;

FIG. 14C shows an example of the one-frame display screen of an album cover image;

FIG. 15 is a flowchart of the contents of the album selecting process;

FIG. 16 is a flowchart of the contents of the image album registering process;

FIG. 17 is a flowchart of the contents of the target image designating process;

FIG. 18A shows an example of the state before an image data file is deleted;

FIG. 18B shows an example of deleting the taken image “P006” from the status shown in FIG. 18A;

FIG. 18C shows the status in which the image “P006” is deleted from “album A” after the deleting operation shown in FIG. 18B;

FIG. 19 is a flowchart of the contents of the taken image deleting process;

FIG. 20 is a flowchart of the contents of the album image deleting process;

FIG. 21A shows an example (1) of the album manipulation function selection screen;

FIG. 21B shows an example of the listing screen of an image contained in an album;

FIG. 21C shows an example of the one-frame display screen of an image contained in an album;

FIG. 21D shows an example of the display screen of a cancel instruction of the image deleting process on an image contained in an album;

FIG. 21E shows an example of the display screen of an execute instruction of the image deleting process on an image contained in an album;

FIG. 22A shows an example of the status before collective deletion of a taken image;

FIG. 22B shows an example of a deletion target file list generated at a taken image collectively delete instruction;

FIG. 22C shows the state of deleting an image data file based on the deletion target file list;

FIG. 22D shows the state of collectively deleting the file name shown in a shooting list;

FIG. 23 is a flowchart of the contents of the taken image collectively deleting process;

FIG. 24 is a flowchart of the contents of the album image collectively deleting process;

FIG. 25A shows an example (2) of the album manipulation function selection screen;

FIG. 25B shows an example of the display screen of a cancel instruction in the process of collectively deleting images contained in an album; and

FIG. 25C shows an example of the display screen of an execute instruction in the process of collectively deleting images contained in an album.

### DESCRIPTION OF THE PREFERRED EMBODIMENTS

The embodiments of the present invention are explained below by referring to the attached drawings.

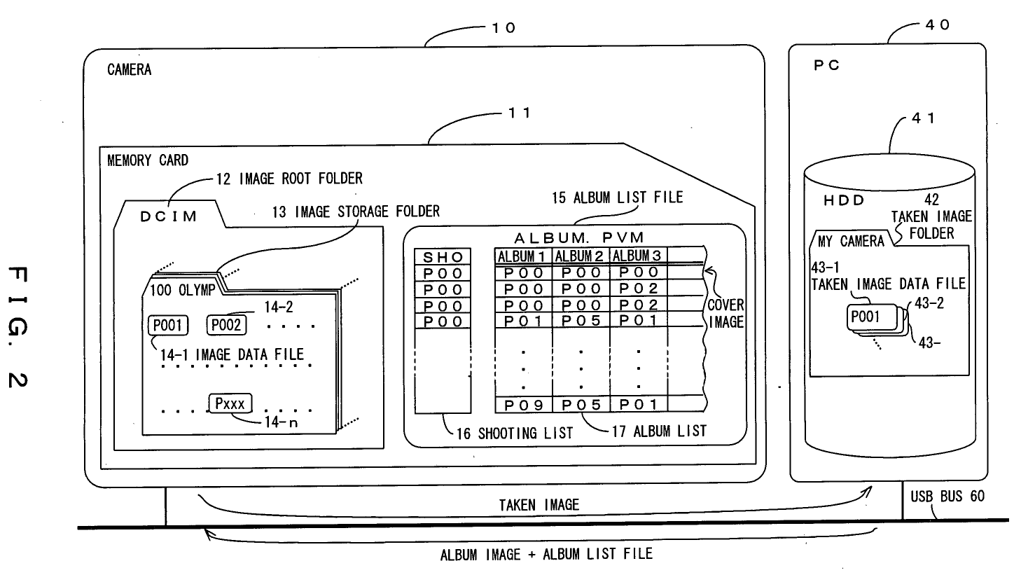

First, the outline of the album function according to an embodiment the present invention is described below by referring to FIG. 2.

FIG. 2 shows the state in which a camera 10 and a PC 40 are connected through a USB (Universal Serial Bus) bus 60, and various data can be alternately received. In the present embodiment, an image taken by the camera 10 is temporarily transferred to the PC 40, an album is generated for the image by the PC 40, and the generated album is transferred from the PC 40 to the camera 10. Therefore, when a user carries the camera 10, the user can browse the album although the PC 40 is not at hand.

The explanation continues below by referring to FIG. 2. The camera 10 is loaded with a removable memory card 11 for storing various data. The memory card 11 stores an image root folder 12 and an album list file 15. They are arranged immediately below the root directory in the record area of the memory card 11.

The image taken near the camera 10 is stored as image data files 14-1, 14-2, . . . , 14-n (hereinafter referred to as “14-n”) in an image storage folder (“100 OLYMP” folder) 13 in the image root folder (“DCIM” folder) 12. As described later, in the image root folder 12, not only an image taken near the camera 10, but also the image data file of an image registered in an album (contained in the album) is stored without being specifically discriminated. Therefore, the file name of the image data file 14-n about the image taken near the camera 10 is added in the taking order to a shooting list (“SHOT”) 16 shown in the album list file 15. Therefore, when the image taken near the camera 10 is transferred from the 10 to the PC 40, the camera 10 searches the image root folder 12 for the image data file 14-n which is the file name shown in the shooting list 16, and transfers it to the PC 40. The PC 40 stores the image data file 14-n transmitted from the camera 10 as a taken image data file (taken image data files 43-1, 43-2, 43-n (hereinafter referred to as a “43-n”) 43-n as a representative in a taken image folder (“MYCAMERA” folder) 42. The taken image folder 42 is provided in a hard disk drive (HDD) in the PC 40.

The album list file (“ALBUM. PVM” file) 15 indicates the relationship (dependence) between each of the image data file 14-n and an album containing the image data file 14-n (to which the image data file 14-n belongs), and an album list 17 having the file name of each file arranged for each album including the file. In the sequence of the file names in the album list 17, the file name of the image data file about the cover image corresponding to the cover of the album is written at the head. The cover image corresponds to the specified image,

As described above, the 15 also shows the shooting list 16.

In the present embodiment, the number of albums managed in the album list 17 is predetermined, and each album is named “ALBUM 1”, “ALBUM 2”, “ALBUM 3”, etc.

The album list file 15 is transmitted from the PC 40 together with the image data file 14-n indicating the image contained in the album. When the image data file 14-n and the album list 17 are transmitted from the PC 40, the camera 10 stores the image data file 14-n in the 13, and the album list file 15 as overwritten immediately below the root directory in the record area of the memory card 11. At this time, the shooting list 16 is held as is in the state before the overwriting. When the memory card 11 having no album list files 15 is attached to the camera 10, it is necessary to record in the shooting list 16 the information about the image taken by the camera 10. Therefore, the album list file 15 is newly generated, and is stored in the memory card 11.

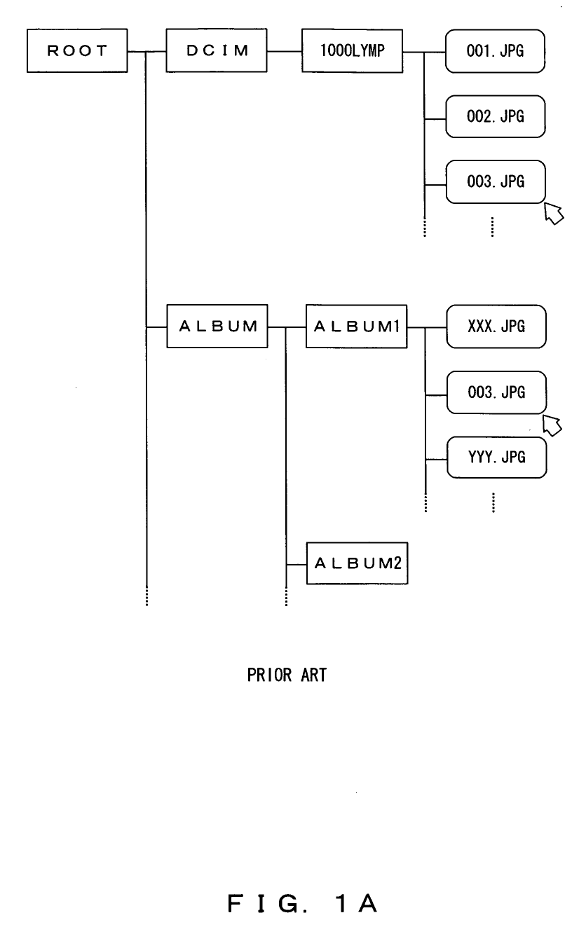

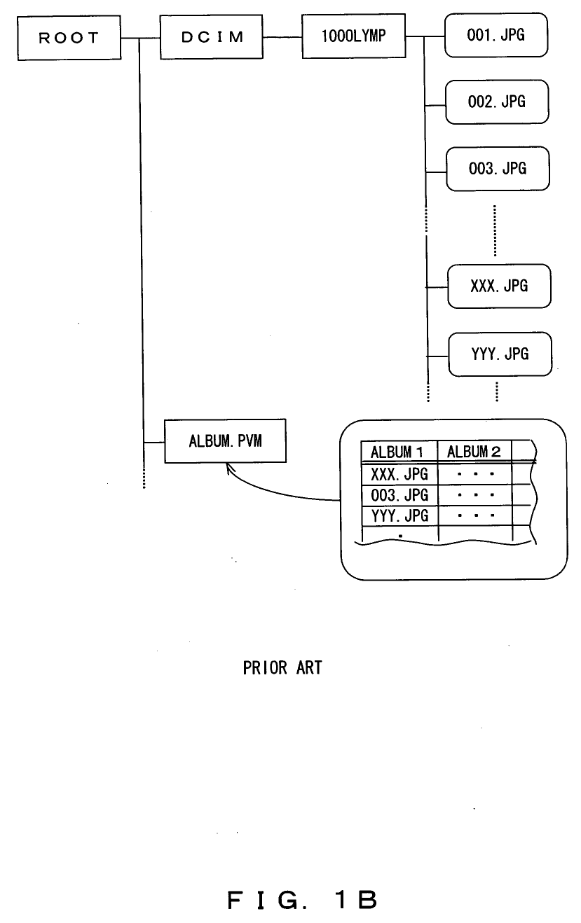

As described above, the management structure of the image data file in the memory card 11 in the camera 10 according to the present embodiment follows the management structure of the image list file shown in FIG. 1B, but has the characteristic of writing the file name of the image data file about the cover image corresponding to the cover of the album at the head in the sequence of file names in the album list 17.

For simple explanation, according to the present embodiment, it is assumed that the file name of the data file having different data contents does not encounter a duplicate in the image root folder 12. Therefore, the image data file 14-n in the image root folder 12 can be uniquely designated only by the file name indicated in the shooting list 16 and the album list 17. The image data file 14-n can also be uniquely designated by indicating in the shooting list 16 and the album list 17 the information about the storage position, etc. of a file in addition to the file generation date and time and the file name although the file name of the image data file 14-n is duplicate in the image root folder 12.

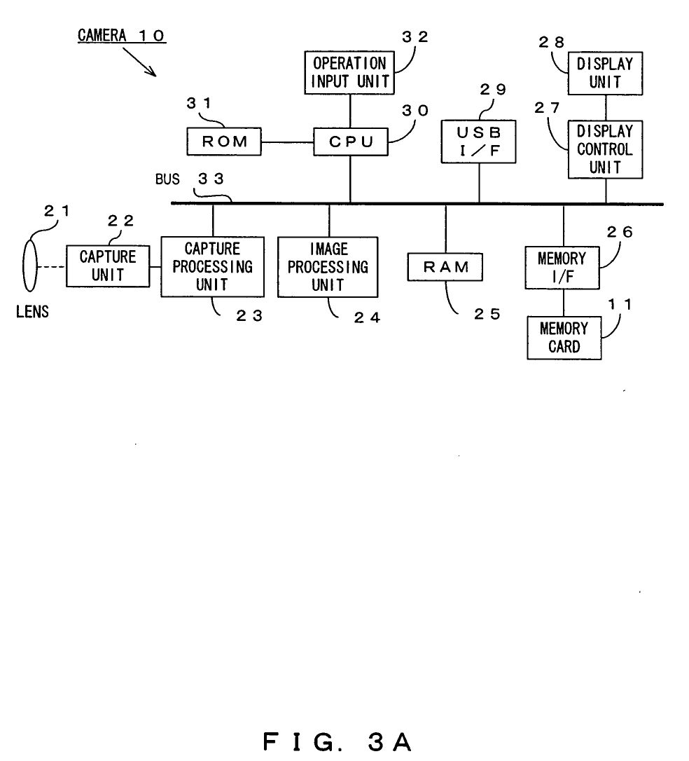

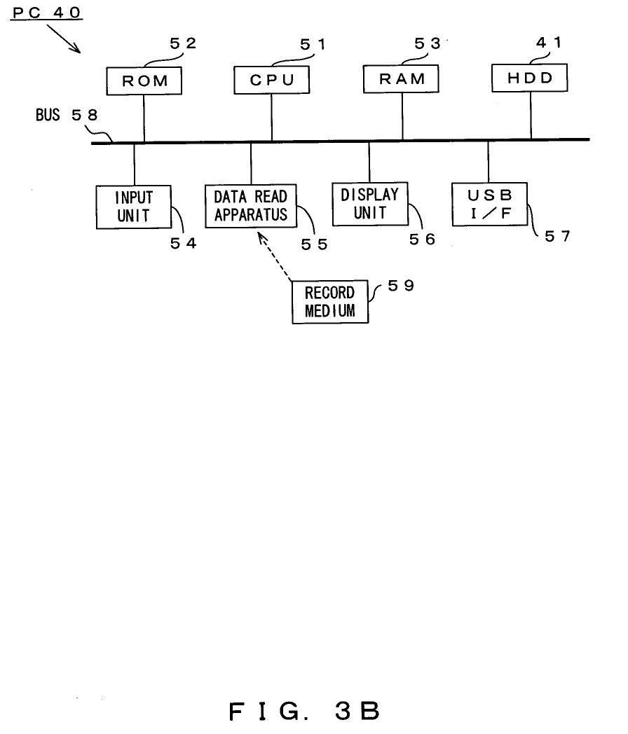

The configurations shown in FIGS. 3A and 3B are described below. These figures show the hardware configuration of the camera 10 and the PC 40 shown in FIG. 2. FIG. 3A shows the configuration of the camera 10, and FIG. 3B shows the configuration of the PC 40.

In FIG. 3A, a capture processing unit 23, an image processing unit 24, RAM 25, memory I/F 26, a display control unit 27, a USB I/F 29, and a CPU 30 are connected to a bus 33 for mutual communications of various data under the management of the CPU 30.

A subject image formed by a lens 21 is input to the capture processing unit 23 after being converted into an electric signal by, for example, a capture unit 22 which is a charge coupled device (CCD). The capture processing unit 23 performs an analog-to-digital conversion after amplifying the input electric signal into a predetermined level, and outputs image data indicating the image displayed as a subject image.

The image processing unit 24 performs image processing such as γ correction, edge emphasis, white balance correction, etc. on an image expressed by the image data output from the capture processing unit 23. When the image data is recorded on the memory card 11, a data compressing process is performed as necessary on the image data. Furthermore, when an image expressed by image data recorded on the memory card 11 is reproduced and displayed, a data decompressing process is performed as necessary on the image data read from the memory card 11.

The RAM 25 is random access memory for work as necessary when the image processing unit 24 and the CPU 30 perform various processes.

The memory I/F 26 is an interface for connection of the memory card 11 to the bus 33, and enables various data to be read and written on the memory card 11 under the management of the CPU 30.

The display control unit 27 performs a digital-to-analog conversion on the image data transmitted through the bus 33, and transmits the result to a display unit 28.

The display unit 28 is, for example, a liquid crystal display (LCD), and displays an image displayed by image data input to the display control unit 27.

The universal serial bus (USB) I/F 29 is an interface for connection of the USB bus 60 to the bus 33 shown in FIG. 2, and enables various data to be communicated between the camera 10 and the PC 40.

The central processing unit (CPU) 30 performs operation control of the entire camera 10.

ROM 31 is read only memory storing a control program to be executed by the CPU 30, and various data for use, as necessary, when the program is executed. The CPU 30 enables the above-mentioned operation control by executing the control program.

An operation input unit 32 includes switches operated by a user of the camera 10, obtains an instruction from a user associated with the contents of the operation, and passes it to the CPU 30.

Described below is the configuration of the PC 40 shown in FIG. 3B.

In FIG. 3B, a CPU 51, ROM 52, RAM 53, an HDD 41, an input unit 54, a data read apparatus 55, a display unit 56, and a USB I/F 57 are connected to a bus 58, and enables various data to be communicated under the management of the CPU 51.

The CPU 51 performs the operation control of the entire PC 40.

The ROM 52 is read only memory storing a basic control program executed by the CPU 51, and various data for use as necessary when the program is executed. The CPU can perform operation control on the entire PC 40 by executing the basic control program.

The RAM 53 is random access memory used for work as necessary when the CPU 51 performs various processes.

The HDD 41 is a magnetic disk storage device storing, in addition to the above-mentioned taken image data file 43-n, various control programs executed by the CPU 51, and various data for use as necessary when the programs are executed.

The input unit 54 is configured by, for example, a pointing device such a mouse, etc. and a keyboard device, etc., and obtains an instruction from a user corresponding to the contents of the operation.

The data read apparatus 55 is, for example, a CD (compact disc)-ROM drive and a DVD (digital versatile disc)-ROM drive, and reads various data stored in a record medium 59 such as the CD-ROM, DVD-ROM, etc. The image management software described later is recorded on the record medium 59 and distributed. The PC 40 reads the image management software from the record medium 59 using the data read apparatus 55, and stores it on the HDD 41 in advance. When a user issues an instruction to execute the management software to the input unit 54, the CPU 51 reads the image management software stored in the HDD 41 and executes it.

The record medium 59 can be a storage device provided for the computer system functioning as a program server connected to the communications circuit such as the Internet, etc. In this case, a transmission signal obtained by modulating a carrier with a data signal representing image management software is transmitted from the program server to the computer through a communications circuit which is a transmission medium. The PC 40 is provided with a connection device to the communications circuit to receive and demodulate the transmission signal, and then regenerate the image management software, thereby executing the image management software by the CPU 51.

The display unit 56 can be an LCD, a cathode ray tube (CRT), etc., and displays a predetermined image at an instruction of the CPU 51.

The USB I/F 57 is an interface for connection between the USB bus 60 shown in FIG. 2 and the bus 58 to enable various data to be communicated between the PC 40 and the camera 10.

The configuration of the PC 40 is a common configuration of a standard computer.

Described below is the image management software executed by the CPU 51 of the PC 40. The software provides the functions such as capturing in the PC 40 an image taken by the camera 10, generating and editing an album, generating a cover image corresponding to the cover of an album, transferring an album to the camera 10, etc. through the PC 40. Described below are various control processes performed by the CPU 51 by executing the image management software.

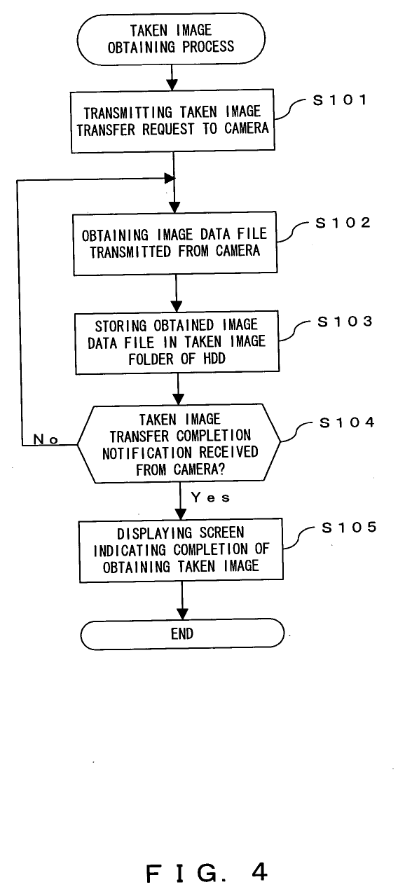

The process shown in FIG. 4 is described below. FIG. 4 is a flowchart of the taken image obtaining process. In this process, the image data file 14-n of the image taken by the camera 10 is received from the camera 10, and stored as the taken image data file 43-n in the taken image folder 42 in the HDD 41. This process is started when the instruction to start the process is issued to the input unit 54 in the PC in which the image management software is being executed, for example, when the operation of clicking by a pointer a button display indicating “read an image” button display is performed for the input unit 54 on the screen of the display on the display unit 56 by the execution of the image management software. The execution can also be started when the CPU 51 detects the connection of the 40 with the camera 10 through the USB bus 60.

First, in S101, the process of transmitting the data addressed to the camera 10 requesting the transfer of a taken image is performed.

When the camera 10 receives the technology request data transmitted through the USB bus 60, the shooting list 16 stored in the memory card 11 is referred to, the image data file 14-n having the file name indicated in the list is read, and the read image data file 14-n is transmitted by the 30 from the USB I/F 29 to the PC 40. When all image data files 14-n whose file names are indicated in the shooting list 16 are completely transferred, the process of transmitting data indicating the notification of the completion of the transfer of taken images is transmitted from the USB I/F 29 to the PC 40 by the CPU 30.

In S102, the process of the USB I/F 57 obtaining the image data file 14-n transmitted from the camera 10 through the USB bus 60 is performed. In S103, the process of storing the obtained image data file 14-n in the taken image folder 42 in the HDD 41 as the taken image data file 43-n is performed.

Then, in S104, the process of determining whether or not the data indicating the notification of the completion of the transfer of a taken image has been transmitted is performed. If it is determined that the notification has been received (YES as the determination result), then in S105, the screen indicating the completion of obtaining taken images is displayed on the display unit 56, thereby terminating the taken image obtaining process. If it is determined in S104 that the notification has not been received (NO as the determination result), then control is returned to S102, and the above-mentioned processes are repeated.

Described above is the taken image obtaining process.

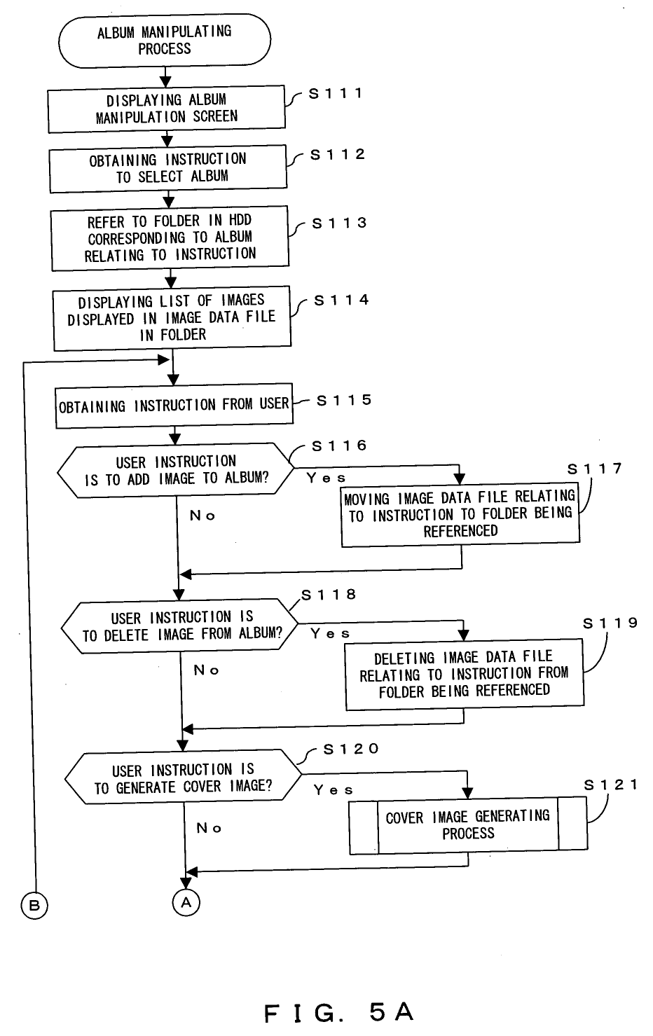

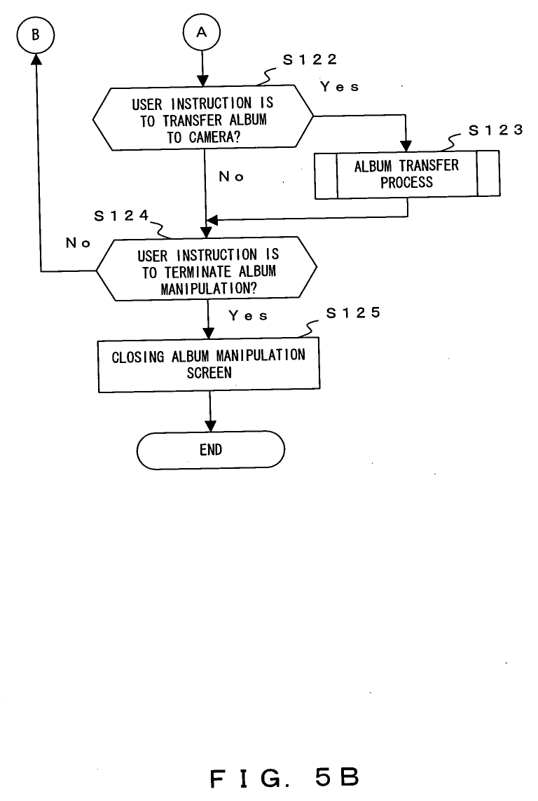

Then, the process shown in FIGS. 5A and 5B is described below. FIGS. 5A and 5B are flowcharts of the album manipulating process. The process is performed to edit an album, generate a cover image corresponding to the cover of an album, generate title characters for a cover image, and transfer an album to the camera 10. This process is started when the instruction to start the process is issued to the input unit 54 in the PC in which the image management software is being executed, for example, when an instruction to operate an album by the operation of clicking by a pointer is performed for the input unit 54 on the screen of the display on the display unit 56 by the execution of the image management software.

First, in S111 shown in FIG. 5A, the process of displaying the album manipulation screen on the display unit 56 is performed.

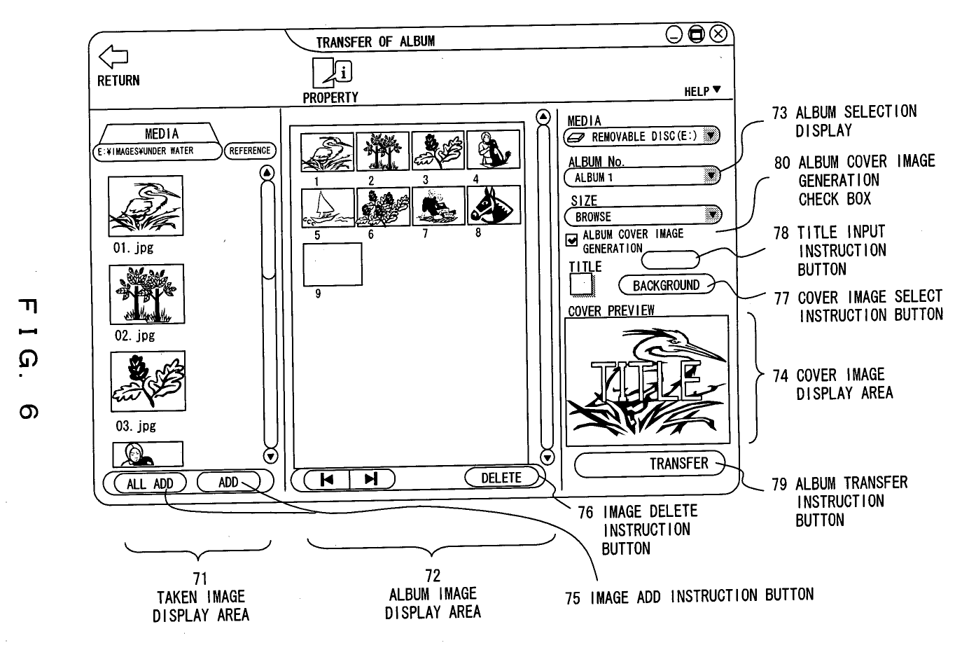

The album manipulation screen is shown as an example in FIG. 6. In the present embodiment, at this time, the taken image data file 43-n stored in the taken image folder 42 in the HDD 41 is read, and a list of images (the images are referred to as “taken images”) displayed in each of the taken image data files 43-n is displayed on a taken image display area 71 shown in FIG. 6.

In S112, the process of obtaining an instruction to select an album to be processed in an album manipulation performed by a user is performed. The selection of an album is performed in a pointer clicking operation, etc. on an album selection display 73 in FIG. 6.

In S113, in the folders stored in the HDD 41, the process of referring to a folder (the folder is referred to as an “album folder”) corresponding to the album relating to the instruction obtained by the process in the previous step.

In S114, the image data file stored in the album folder being referenced is read, and a list of images (referred to as “album images”) represented by the read image data file is displayed on the album manipulation screen being displayed on the display unit 56. In the example of the screen shown in FIG. 6, the list of images is displayed on an album image display area 72. When the album folder includes the image data file of the cover image, the cover image represented by the image data file is displayed on a cover image display area 74.

In S115, the process of obtaining an instruction from a user corresponding to the operation performed on the input unit 54 is performed. In the example of a screen shown in FIG. 6, the instruction refers to a clicking operation of one of an image add instruction button 75, an image delete instruction button 76, a cover image select instruction button 77, a title input instruction button 78, and an album transfer instruction button 79.

In S116, the process of determining whether or not the instruction obtained in the process in S115 relates to the image add instruction button 75 in FIG. 6, that is, the instruction to add a taken image to an album. Only when the determination result is YES, the process of moving the image data file of taken images relating to the instruction to the album folder being referenced is performed in S117.

In FIG. 6, an “all add” button and an “add” button are provided as image add instruction buttons 75. The “all add” button indicates the movement of an image data file of taken images to an album folder currently being referenced, and the “add” button indicates the movement of an image data file of only selected images in taken images in the operation on the input unit 54.

In the example of the screen shown in FIG. 6, when an image data file is moved, the display position of a taken image relating to an instruction is moved from the taken image display area 71 to the trailing position of the image list of the album image display area 72.

In S118, the process of determining whether or not the instruction obtained in the process in S115 relates to the image delete instruction button 76 in FIG. 6, that is, a delete instruction from the album of album images is performed. Only when the determination result is YES, the process of deleting an image data file of album images relating to the instruction from the album folder currently being referenced is performed in S119.

In FIG. 6, clicking the image add instruction button 75 is an instruction to delete an image data file of selected album images in the album images in the operation performed on the input unit 54 from the album folder currently being referenced.

In the example of a screen shown in FIG. 6, when the image data file is deleted, the displayed album image related to the instruction is removed from the image list of the album image display area 72.

In S120, the process of determining whether or not the instruction obtained in the process in S115 relates to the generation of a cover image, that is, an instruction for the cover image select instruction button 77 or the title input instruction button 78 in FIG. 6, is performed. Only when the determination result is YES, the cover image generating process is performed in S121. The details of the cover image generating process are described later.

Control is passed to FIG. 5B, and the process of determining whether or not the instruction obtained in the process in S115 shown in FIG. 5A is an instruction for the album transfer instruction button 79 in FIG. 6, that is, a transfer instruction to the camera 10 of the album, is performed in S122. Only when the determination result is YES, the album transfer process is performed in S123. The details of the album transfer process are described later.

In S124, the process of determining whether or not the instruction obtained in the process in S115 shown in FIG. 5A is an instruction to terminate the album manipulating process is performed. When the determination result is YES, the process of closing the album manipulation screen displayed on the display unit 56 is performed in S125, thereby terminating the album manipulating process. When the determination result is NO in S124, control is returned to S115 shown in FIG. 5A, and the above-mentioned processes are repeated.

Described above is the album manipulating process.

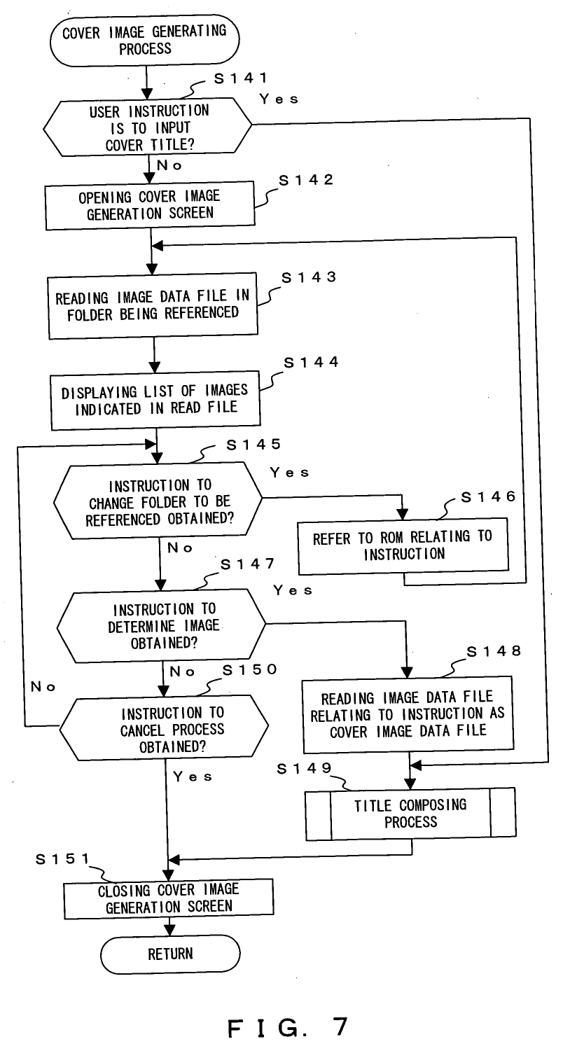

The cover image generating process performed in S121 (FIG. 5A) in the above-mentioned album manipulating process is explained below. The content of the cover image generating process is shown in the flowchart in FIG. 7.

First, in S141, the process of determining whether or not the instruction obtained in the process in S115 in the above-mentioned album manipulating process is related to the title input instruction button 78 in FIG. 6, that is, the instruction to input a title for the already set cover image, is performed. If the determination result is YES, control is passed to S149. If the determination result is NO, that is, the instruction is related to the cover image select instruction button 77 in FIG. 6, control is passed to S142.

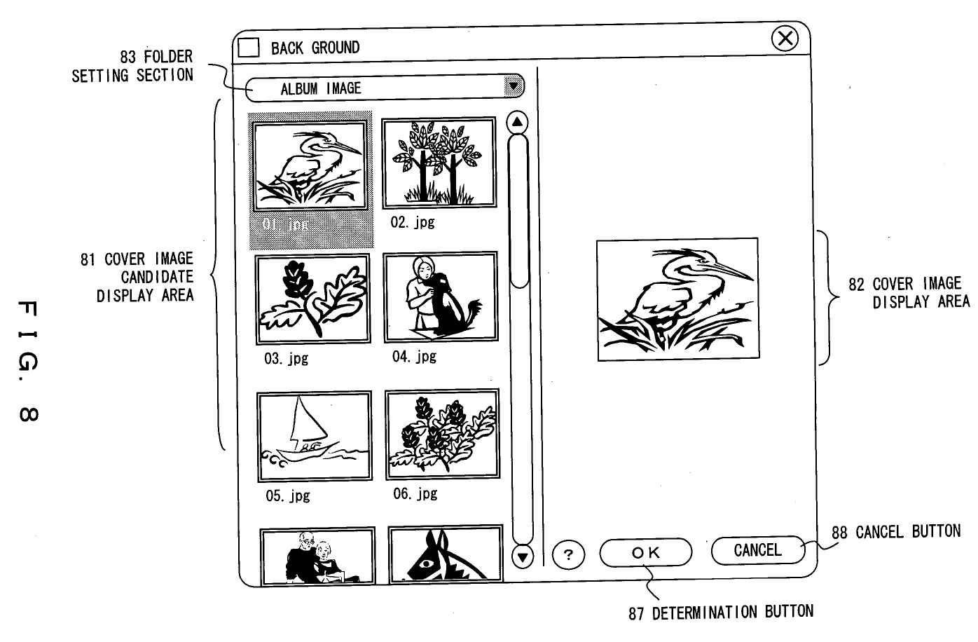

In S142, the process of opening the cover image generation screen (display on the display unit 56) is performed. FIG. 8 shows an example of the cover image generation screen.

In S143, the process of reading all image data files in the album folder currently being referenced is performed. Then, in S144, the process of displaying a list of album images displayed in each read image data file on the cover image generation screen being displayed on the display unit 56 is performed. In the example of the screen shown in FIG. 8, the list of album images is displayed on a cover image candidate display area 81. These album images are candidates for a cover image. When a user performs an operation corresponding to the instruction to select an image from among these images on the input unit 54, the image is displayed on a cover image display area 82.

In S145, the process of determining whether or not an instruction to change a candidate image for a cover image has been obtained by changing a folder to be referenced, or whether or not an instruction to change a folder to be referenced is obtained by a clicking operation, etc. on a folder setting section 83 in the example of the screen in FIG. 8. If the determination result is YES, then in S146, the process of referencing a folder related to the obtained instruction is performed, and then the process of repeating the above-mentioned processes after returning control to S143 is repeated. The process enables the cover image of an album to be processed in an album manipulation to be selected from among the images other than the album image contained in the album. If the determination result in S145 is NO, then control is passed to step S147.

In S147, the process of determining whether or not an instruction to determine a cover image has been obtained, or an operation for a determination button 84 has been performed in the example of the screen shown in FIG. 8. If the determination result is YES, then in S148, the file name of the image data file for the image related to the determination instruction is read as an image data file (cover image data file) of cover images, and temporarily stored in a predetermined area of the RAM 53. Then, in S149, the title composing process is performed, thereby passing control to S151. The details of the title composing process are described later. In the example of the screen of the album manipulation screen in FIG. 6, the image displayed on the cover image display area 74 up to this point is switched into a cover image related to the determination instruction.

When the determination result in S147 is NO, control is passed to S150.

In S150, the process of determining whether or not an instruction to cancel the cover image generating process, or whether or not an operation for a cancel button 85 in the example of the screen shown in FIG. 8, is performed. If the determination result is YES, control is passed to S151. If the determination result is NO, then control is returned to S145, and the above-mentioned processes are repeated.

In S151, the process of closing (erasing) the cover image generation screen being displayed on the display unit 56 is performed, thereby terminating the cover image generating process and returning control to the album manipulating process shown in FIG. 5A.

Described above is the cover image generating process.

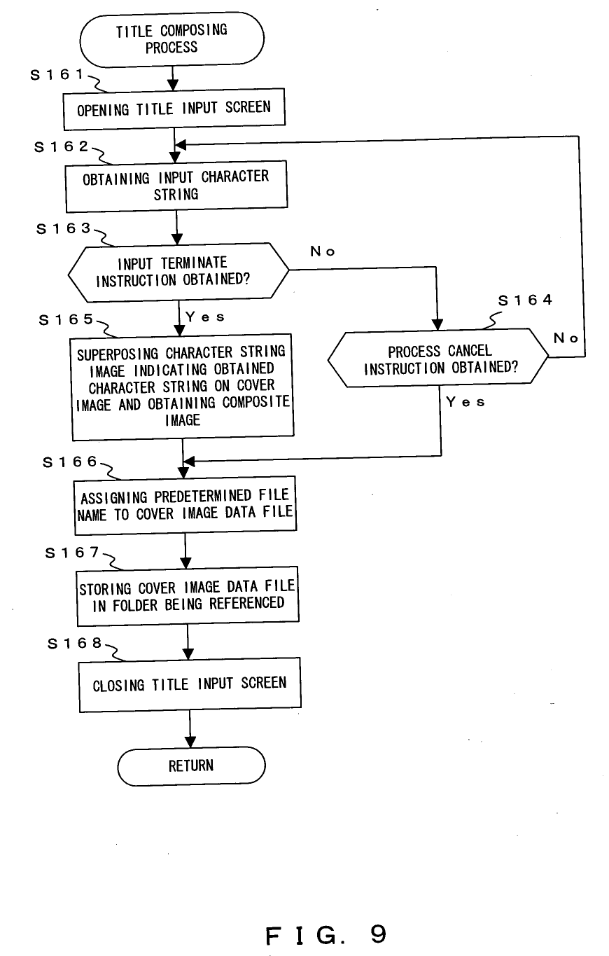

The title composing process in S149 in the above-mentioned cover image generating process is explained below. FIG. 9 is a flowchart of the title composing process.

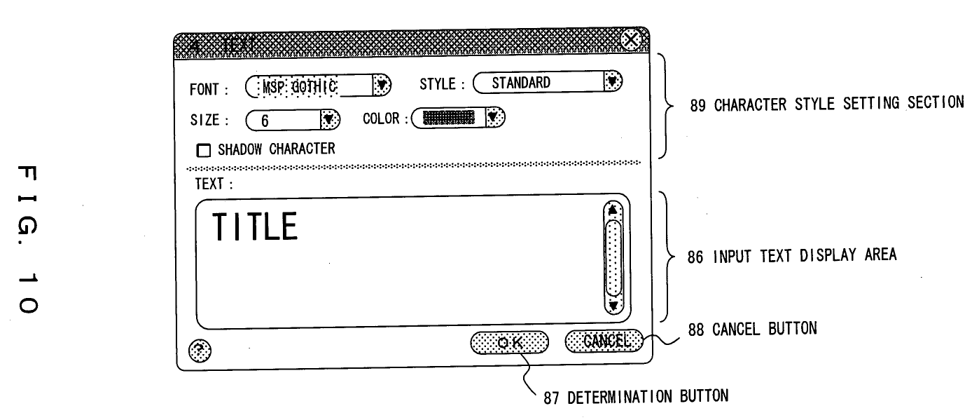

In S161, the process of opening the title input screen (display on the display unit 56) is performed in S161. FIG. 10 shows an example of the title input screen.

In S162, the process of obtaining the contents of the input character string corresponding to the operation performed on the input unit 54 by a user is performed. In the example of the screen shown in FIG. 10, the contents of the obtained character string are displayed on an input text display area 86.

In S163, the process of terminating the input of a character string, determining whether or not an instruction to determine a character string has been obtained, or determining whether or not the operation for a determination button 87 has been performed in the example of the screen shown in FIG. 10 is performed. If the determination result is YES, then control is passed to S165. If the determination result is NO, then in S164, the process of determining whether or not an instruction to cancel the title composing process has been obtained, or whether or not the operation for a cancel button 85 has been performed on the example of the screen shown in FIG. 10 is performed. If the determination result is YES, control is passed to S166. If the determination result is NO, control is returned to S162 and the above-mentioned processes are repeated.

In S165, the process of generating a character string image indicating the character string obtained in the process in S162, superposing the generated character string image on the cover image indicated by the cover image data file stored in a predetermined area in the RAM 53 in the process in S147 in the above-mentioned cover image generating process (FIG. 7) and obtaining a composite image, and storing the image data file of the obtained composite image as a cover image data file in the area of the RAM 53 is performed. In the example of the screen in FIG. 10, the character string image of the shape, size, and color set in a character style setting unit 89 is generated.

In S166, the process of assigning a predetermined file name to the cover image data file stored in a predetermined area of the RAM 53 is performed. In S167, the process of adding the cover image data file to the album folder currently being referenced and storing the result is performed. In the example of the screen of the album manipulation screen shown in FIG. 6, the image displayed on the 74 up to this point is switched into the display image on which the character composing process has been performed.

In S168, the title input screen being displayed on the display unit 56 is closed (erased). Then, the title composing process is terminated, and control is returned to the cover image generating process shown in FIG. 7.

Described above are the title composing process. By composing a character string image representing a title on a cover image, the camera 10 having no font data of characters such as Kanji, etc. can display the title of an album, and the characters indicating the title can be displayed in various styles.

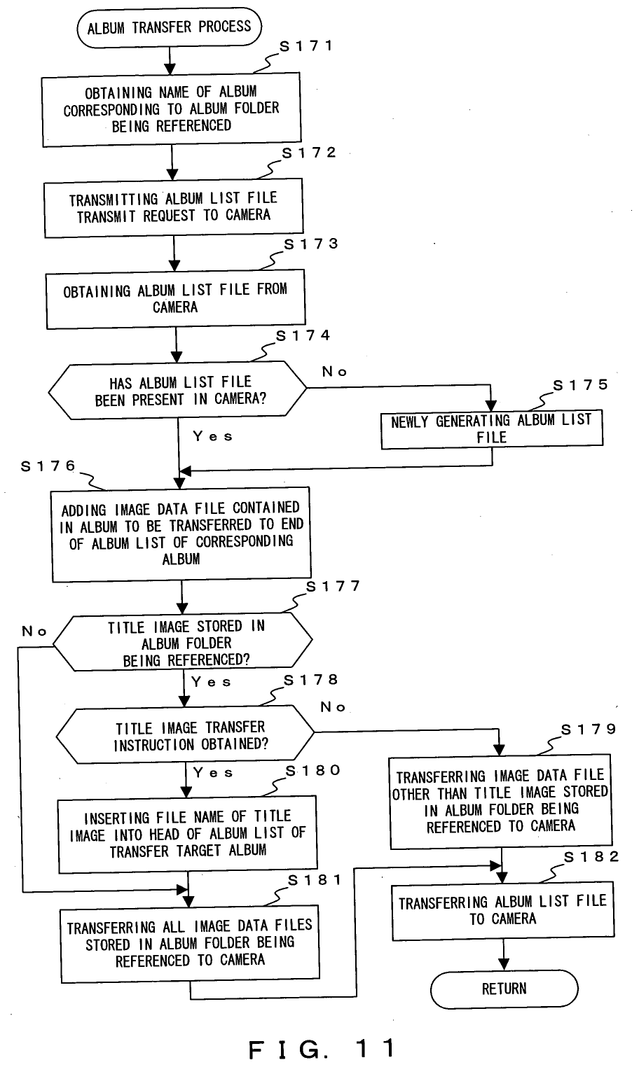

Described below is the album transfer process which is the process in S123 (FIG. 5B) in the above-mentioned album manipulating process. FIG. 11 is a flowchart showing the contents of the album transfer process.

In S171, the title of an album corresponding to the album folder currently being referenced is obtained.

In S172, the data addressed to the camera 10 indicating the request to transmit the album list file 15 stored in the memory card 11 of the camera 10 is transmitted from the USB I/F 57. The details of the process performed in the camera 10 which receives the transmit request are described later.

In S173, the album list file 15 transmitted from the camera 10 at the above-mentioned request is received and obtained by the USB I/F 57.

The details are described later, but the data informing that there is no album list file 15 can be transmitted from the camera 10. If the data is transmitted, the information is received and obtained. In S174, it is determined whether or not the album list file 15 has been present in the camera 10. Only when there has never been the album list file 15 (the determination result is NO), the album list file 15 is newly generated in S175.

In S176, a list of the album having the album name obtained in S171 in the album list 17 in the album list file 15 is referred to, and the file name of the image data file contained in the album folder in the HDD 41 currently being referenced is added one by one to the end of the file name sequence of the image data file in the list.

In S177, it is determined whether or not an image data file of a cover image is stored in the album folder currently being referenced. If the determination result is YES, control is passed to S178. If the determination result is NO, control is passed to S181.

In S178, it is determined whether or not an instruction to transfer a title image has been obtained. If the determination result is YES, control is passed to S180. If it is NO, control is passed to S179. The instruction to transfer the title image is determined based on whether or not there is a check mark in an album cover image generation check box 80 in the example of the album manipulation screen shown in FIG. 6.

In S179, all image data files excluding those related to a cover image in the image data files contained in the album folder currently being referenced are transmitted from the USB I/F 57 to the camera 10, then control is passed to S182.

In S180, in the list of the albums to which the file names are added in the process in S176, the file name of the image data file of cover images stored in the album folder currently being referenced is moved to the head of the list, and inserted therein. In this process, the file name of the image data file of cover images is indicated at the head of the list of the album in the album list 17.

By changing the contents of the process in S180, and moving the file name of the image data file of cover images stored in the album folder currently being referenced to the end of the list and inserting therein, the cover image can be reproduced and displayed at the end of the album image when the album image is sequentially reproduced. This enables the cover image generated in the above-mentioned process to be processed as if it were the back cover of the album.

In S181, all image data files contained in the album folder currently being referenced are transmitted from the USB I/F 57 to the camera 10.

In S182, the album list file 15 in which a file name is added to the album list 17 is transmitted from the USB I/F 57 to the camera 10, thereby terminating the album transfer process, and passing control to the album manipulating process shown in FIG. 5B.

Described above is the album transfer process.

The control processes performed by the CPU 30 of the camera 10 are described below. The processes can be realized by the CPU 30 executing a control program stored in the ROM 31.

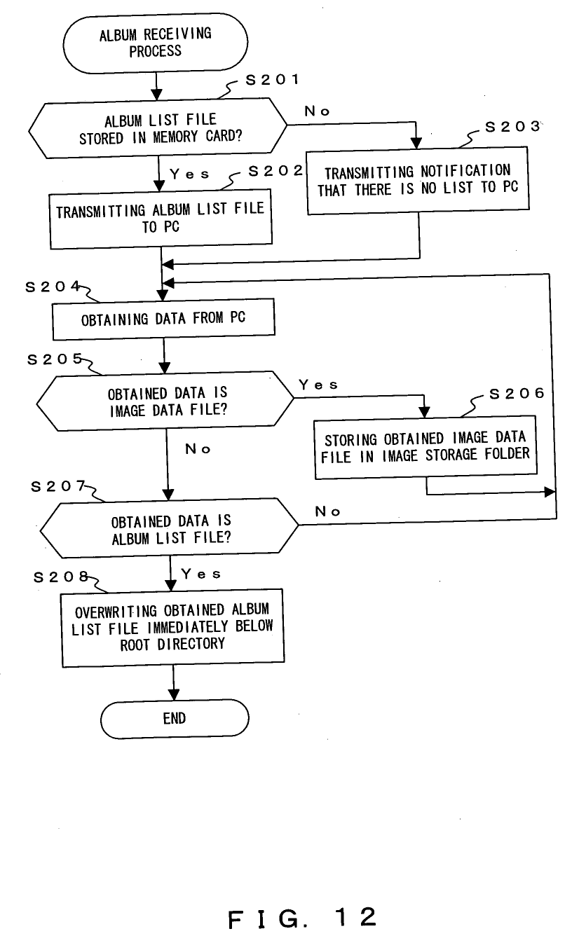

The album receiving process shown in the flowchart in FIG. 12 is described below. The process is to receive by the camera 10 the data about an album transmitted from the PC 40, and started when the CPU 30 detects that the USB I/F 29 has received the data indicating the request to transmit the album list file 15 after the album transfer process is performed by the PC 40.

First, in S201, it is determined by searching the memory card 11 whether or not the album list file 15 has been stored. When it is stored (the determination result is YES), the album list file 15 is read in S202, and transmitted to the PC 40 from the USB I/F 29. If it is not stored (the determination result is no), the USB I/F 29 transmits to the PC 40 the data informing that there is no album list file 15 in S203. The data transmitted in the process in S202 or S203 is received by the PC 40 which performs the process in S173 in the above-mentioned album transfer process.

In S204, the data transmitted from the PC 40 depending on the data transmitted in the process in S202 or S203 is received and obtained by the USB I/F 29.

In S205, it is determined whether or not the data obtained in the previous step is image data file. If the determination result is YES, the obtained image data file is stored in the image storage folder 13 in the image root folder 12 of the memory card 11 in S206, and then control is passed to S204 to repeat the above-mentioned processes.

When the determination result in S205 is NO, it is determined in S207 whether or not the data obtained in the process in S204 is the album list file 15. The PC 40 which performs the above-mentioned album transfer process first completes transmitting all image data files to be transferred and then transmits the album list file 15 in the process in S179, S181, and S182. Therefore, when the determination result in S207 is YES, it is recognized that the album transfer process being performed by the PC 40 has been completed, thereby passing control to S208. On the other and, when the determination result in S207 is NO, control is returned to S204 and the above-mentioned process is repeated.

In S208, the album list file 15 obtained in the process in S204 is overwritten immediately below the root directory of the memory card. At this time, the shooting list 16 which is indicated in the album list file 15 before the overwriting is held as is, thereby terminating the album receiving process.

Described above is the album receiving process.

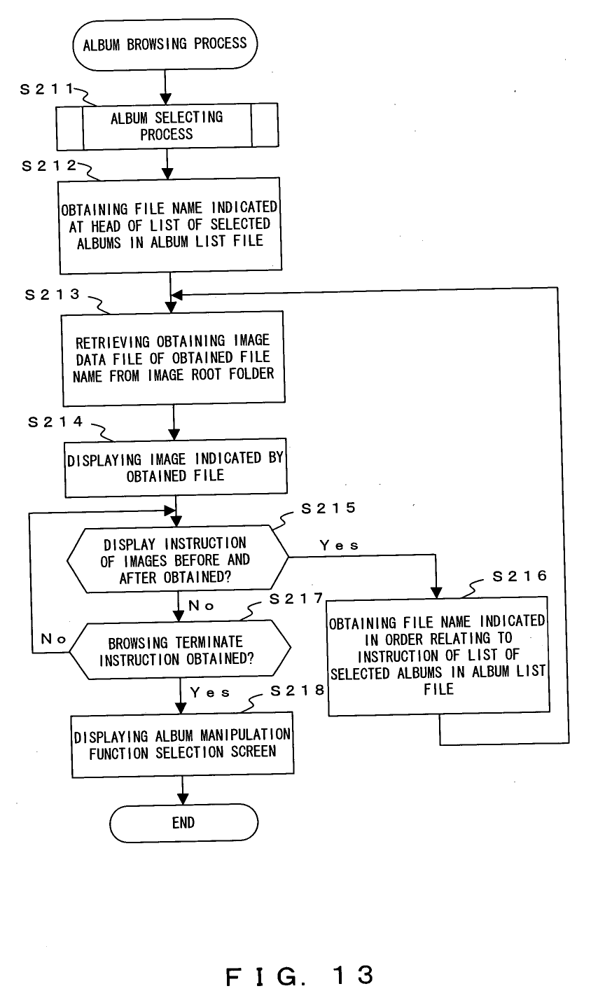

The album browsing process shown by the flowchart in FIG. 13 is explained below. The process is to browse by the camera 10 the album transmitted from the PC 40.

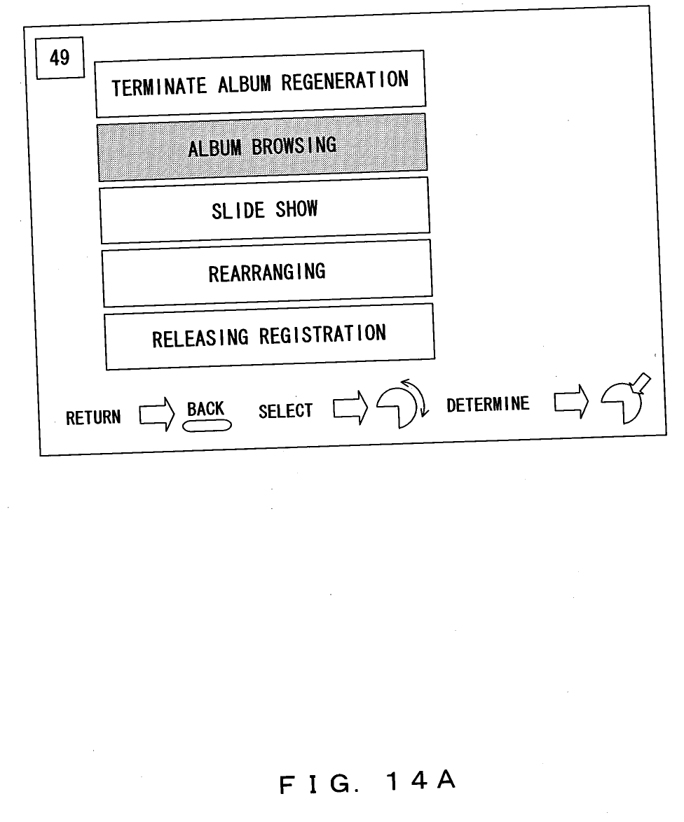

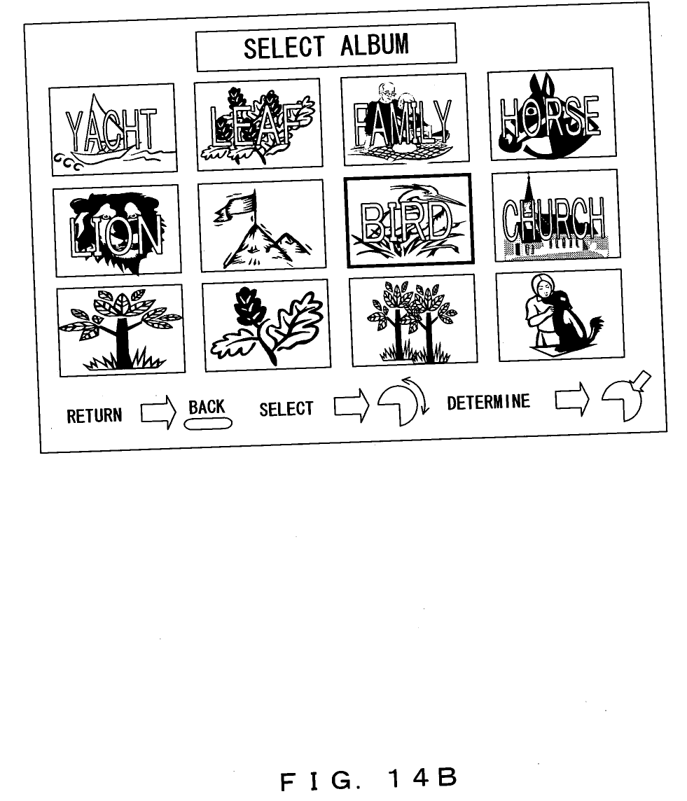

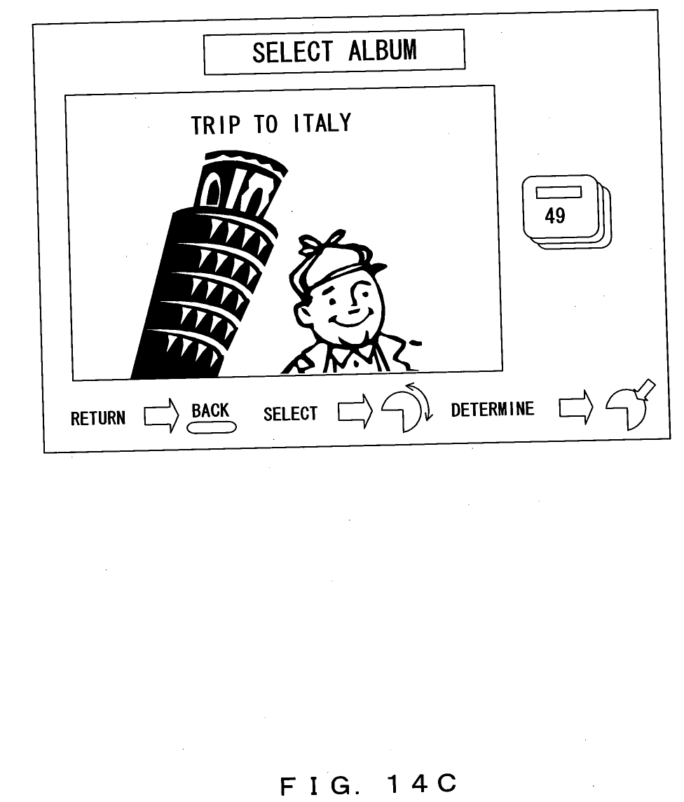

The album browsing process is started when a user operates the operation input unit 32 and displays the album manipulation function selection screen as shown in FIG. 14A on the display unit 28, and when the function of “album browsing” is selected in a further operation performed on the operation input unit 32.

First, in S211, the album selecting process is performed. The process is to select what is browsed from among a plurality of albums held by the camera 10, and the details are described later.

In S212, the album list 17 shown in the album list file 15 stored in the memory card 11 is referred to, and the leading file name in the file names arranged corresponding to the selected album in the process in S211 is obtained.

In S213, the image data file 14-n which is the file name obtained in the process performed immediately before is searched for in the image root folder 12 of the memory card 11 and obtained.

In S214, an instruction is given to the image processing unit 24 and the display control unit 27, and the image represented by the file obtained in the previous step is displayed on the display unit 28.

In S215, it is determined whether or not an instruction to change performed by a user on the operation input unit 32 from the display image currently being referenced on the display unit 28 to the image before or after the current image has been obtained. If the instruction is obtained (the determination result is Yes), then control is passed to S216. If it is not obtained (the determination result is No), then control is passed to S217. The processes are continued.

In S216, the album list 17 shown in the album list file 15 stored in the memory card 11 is referred to, and the file name in the order related to the instruction determined to have been obtained in the process in S215 in the file names arranged and associated with the album selected in the process in S211 is obtained. Then, control is returned to S213, and the above-mentioned processes are repeated.

In S217, it is determined whether or not an instruction to terminate the browsing of an album has been obtained by the operation performed by a user on the operation input unit 32. If the instruction is obtained (YES as a determination result), the album manipulation function selection screen as shown in FIG. 14A is displayed again in S218, and then the album browsing process is terminated. If the determination result in S217 is NO, control is returned to S215, and the above-mentioned processes are repeated.

Described above is the album browsing process.

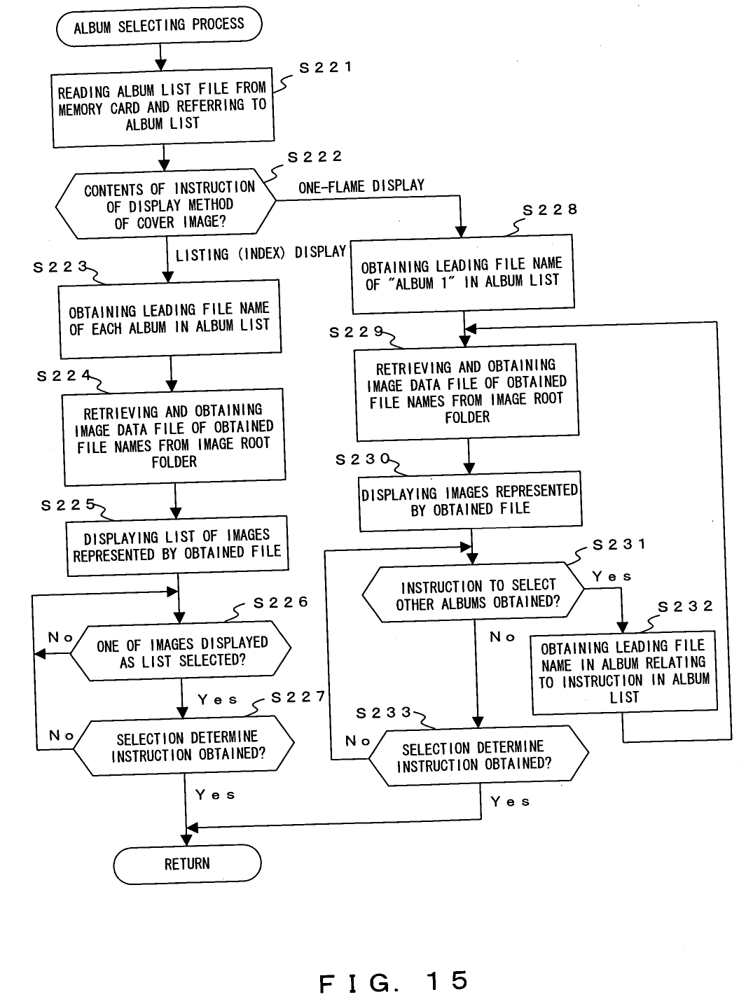

The album selecting process which is the process in S211 in the album browsing process is explained below. FIG. 15 is a flowchart of the album selecting process.

First, in S221, the album list file 15 is read from the memory card 11, and the album list 17 is referred to.

In S222, it is determined what is the instruction on the display method on the display unit 28 of the cover image of an album in the operation of a user on the operation input unit 32. When the contents of the instruction is to listing display (index display) cover images of a plurality of albums, control is passed to S223. When the contents of the instruction are to display a cover image of an album one by one (one-frame display), control is passed to S228.

In S223, the leading file name in the sequence of file names of the image data file 14-n in each album of the album list 17 is obtained. The leading file name relates to the image data file 14-n of the cover images of each album by the process in S180 (FIG. 11) in the above-mentioned album transfer process.

In S224, the image data file 14-n which is the file name obtained in the process in the previous step is obtained by searching the image root folder 12 of the memory card 11.

In S225, an instruction is given to the image processing unit 24 and the display control unit 27, and the cover image indicated in the image data file 14-n obtained in the process in the previous step is displayed on the display unit 28.

In S226, it is determined whether or not an instruction to select one of the cover images displayed as a listing on the display unit 28 has been issued in the operation by a user on the operation input unit 32. Until the instruction is issued (until the determination result is YES), the process in S226 is repeated.

In S227, it is determined whether or not an instruction to determine one of the specified cover images is selected is obtained in the operation by a user on the operation input unit 32. If the determine instruction is issued (when the determination result is YES), the album selecting process is terminated, and control is passed to the original process. If the determine instruction has not been issued (if the determination result is NO), control is returned to S226, and the above-mentioned processes are repeated.

In S228, leading name of the file names of the image data file 14-n about the album name “ALBUM 1” in the album list 17, that is, the file name of the image data file 14-n which is the cover image of the album, can be obtained.

In S229, the image data file 14-n which is the file name obtained in the process 2 performed immediately before is retrieved from the image root folder 12 of the memory card 11 and obtained.

In S230, an instruction is given to the image processing unit 24 and the display control unit 27, and the cover image indicated in the image data file 14-n obtained in the process in the previous step is displayed on the display unit 28.

In S231, it is determined whether or not an instruction to select another album different from an album displaying a representative image on a display unit 18 has been obtained in the operation by a user on the operation input unit 32. When the instruction is obtained (when the determination result is YES), the leading name in the sequence of file names of the image data file 14-n about the album relating to the instruction in the album list 17 is obtained in S232. Then, control is returned to S229, and the above-mentioned process is repeated.

On the other hand, when the above-mentioned instruction has not been obtained (when the determination result is NO), it is determined in S233 whether or not the instruction to determine the selection of one of the specified cover images has been obtained in the operation by a user on the operation input unit 32. The determine instruction is issued (when the determination result is YES), the album selecting process is terminated and control is returned to the original process. If the determine instruction has not been issued (when the determination result is NO), control is returned to S231, and the above-mentioned processes are repeated.

The above-mentioned process is the album selecting process.

Various processes explained above are performed by the CPU 51 of the PC 40 and the CPU 30 of the camera 10, thereby controlling the consumption of the recorded data amount in the memory card 11 and possibly managing the relationship between the album and the cover images of the album.

In the above-mentioned embodiment, the PC 40 generates and edits an album, but each process shown in FIGS. 5A, 5B, 7, and 9 are performed by the CPU 30 of the camera 10, thereby realizing the generation and edition of an album performed on the 10. Furthermore, in the above-mentioned embodiment, browsing an album including the display of a representative image is performed by the camera 10, but each process shown in FIGS. 13 and 15 is performed by the CPU 51 of the HDD 41k, thereby allowing the PC 40 to perform browsing an album including the display of representative image.

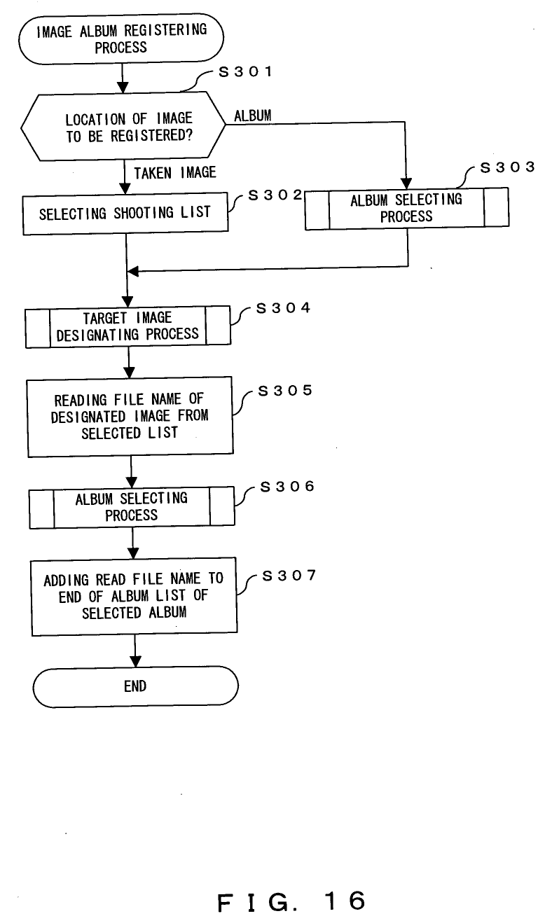

Described below is the process contents of the image album registering process indicated in the flowchart of FIG. 16. The process is to perform additional registration of an image in the taken image and in another album to the current album.

The image album registering process is started when a user operations the operation input unit 32 and the execution of the process is specified.

In S301, it is determined where is the location of the image which is an additional registration target. If it is determined that the instruction is to process the taken image as an additional registration target, then the shooting list 16 contained in the album list file 15 stored in the memory card 11 is a selection result in S302, then control is passed to S304. In S301, if it is determined that the instruction processes the image contained in the album as an additional registration target, then the album selecting process (FIG. 15) is performed in S303, and as the execution result, one of the albums indicated in the album list 17 contained in the album list file 15 is a selection result.

In S304, the target image designating process is performed. This process designates an image which is an additional registration target in the file names of the image data file indicated in the selected list, and the details of the process are described later.

In S305, the file name of the image data file 14-n indicating an image designated in process in the previous step is read from the shooting list 16 selected in the process in S302 or the list of the albums selected in the album selecting process in S303 in the album list 17.

In S306, the above-mentioned album selecting process (FIG. 15) is executed, and as an execution result, one of the albums indicated by the album list 17 contained in the album list file 15 is a selection result.

In S307, the file name read in the process in S305 is added to the end of the list (a sequence of file names of the image data file 14-n) of the selected albums in the album selecting process in S306 in the album list 17, then the image album registering process terminates.

Described above is the image album registering process.

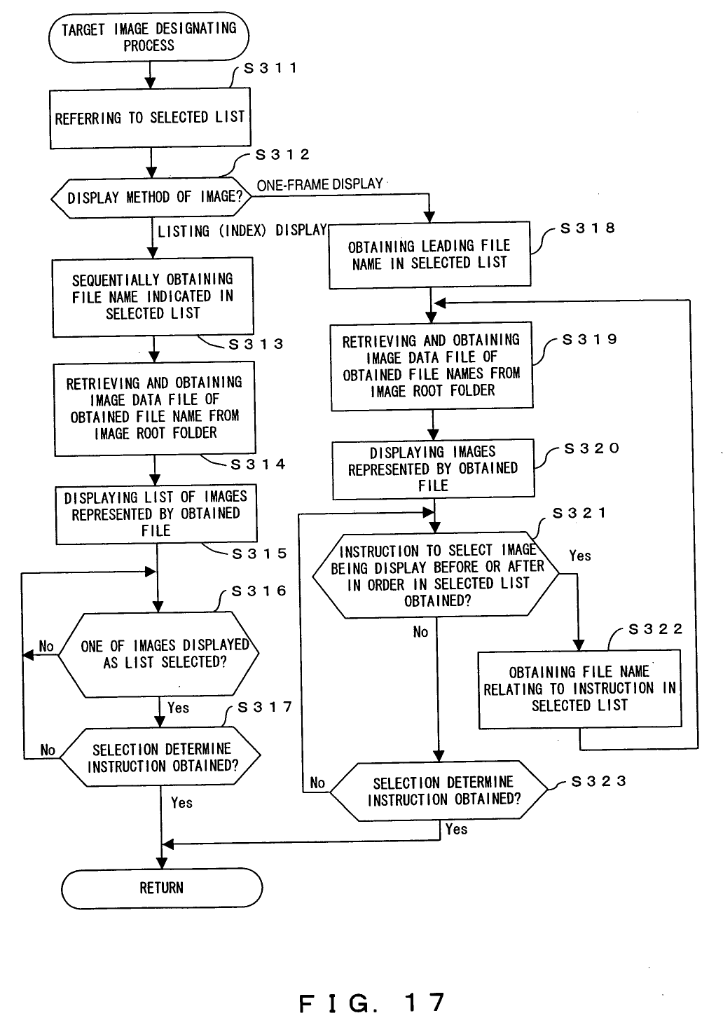

Then, the target image designating process which is the process in S304 in the above-mentioned image album registering process is explained below. The contents of the target image designating process are shown in FIG. 17. As it is clearly indicated by the comparison result between FIGS. 17 and 15, the contents of the target image designating process are similar to those of the contents of the album selecting process.

First, in S311, the list of the album selected by the album selecting process in S303 in the shooting list 16 or the album list 17 selected in the process in S302 is referred to.

In S312, it is determined what are the contents of the instruction about the method of displaying an image on the display unit 28 performed by a user in the operation on the operation input unit 32. If the content of the instruction is a listing display (index display) of a plurality of images, then control is passed to S313. If the contents of the instruction are to display an image one by one (one-frame display), then control is passed to S318.

In S313, a file name indicated by a selected list is sequentially obtained. Then in 314, the image data file 14-n which is the obtained file name is obtained by retrieving it from the image root folder 12 of the memory card 11.

In S315, an instruction is given to the image processing unit 24 and the 27, and the cover image displayed by the image data file 14-n obtained in the process in the previous step is displayed on the display unit 28.

In S316, it is determined whether or not an instruction to select one of the images displayed in a listing on the display unit 28 has been issued. Until the instruction is issued (until the determination result is YES), the process in S316 is repeated.

In S317, it is determined whether or not an instruction to determine the selection of one of the specified images has been obtained in the operation by a user on the operation input unit 32. When the determine instruction is issued (when the determination result is YES), the target image designating process is terminated, and control is returned to the original process. If the determine instruction has not been issued (determination result is NO), then control is passed to S316, and the above-mentioned processes are repeated.

In S318, the leading name in the sequence of the file names in the selected list is obtained.

In S319, the image data file 14-n which is a file name obtained in the process performed immediately before is retrieved from the image root folder 12 of the memory card 11, and obtained.

In S320, an instruction is given to the image processing unit 24 and the display control unit 27, and the cover image indicated in the image data file 14-n obtained in the process in the previous step is displayed on the display unit 28.

In S321, it is determined whether or not an instruction to select an image of the file name in the order before or after the file of the image data file indicating the image being displayed on the display unit 18 in the selected list has been obtained in the operation by a user on the operation input unit 32. If the instruction is obtained (the determination result is YES), the file name in the order relating to the instruction in the list selected in S322 is obtained. Afterwards, control is returned to S319, and the above-mentioned processes are repeated.

On the other hand, if the instruction has not been obtained (the determination result is NO) in S321, it is determined whether or not an instruction to determine the selection of an image being displayed on the display unit 18 has been obtained in S323 in the operation by a user on the operation input unit 32. When the determine instruction has been issued (determination result is YES), the target image designating process is terminated, and control is returned to the original process. When the determine instruction is not issued (determination result is NO), control is returned to S321, and the above-mentioned processes are repeated.

Described above is the target image designating process.

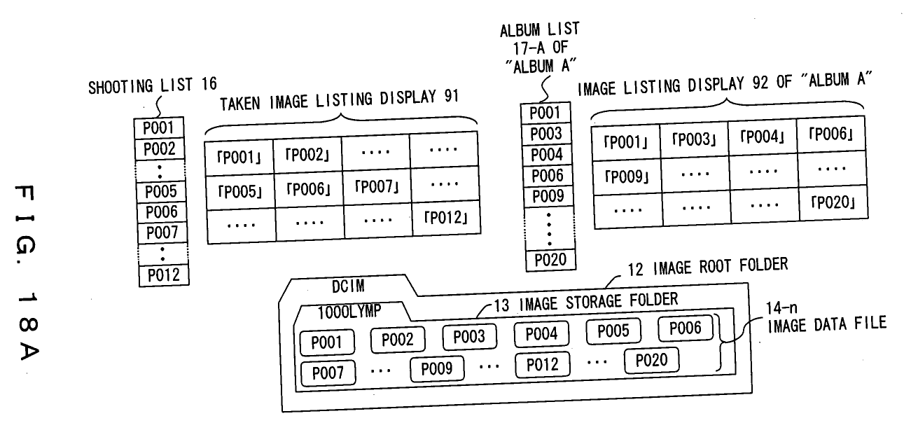

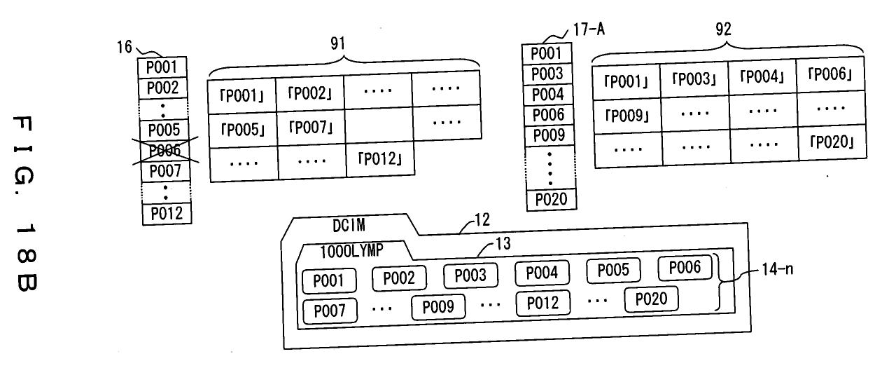

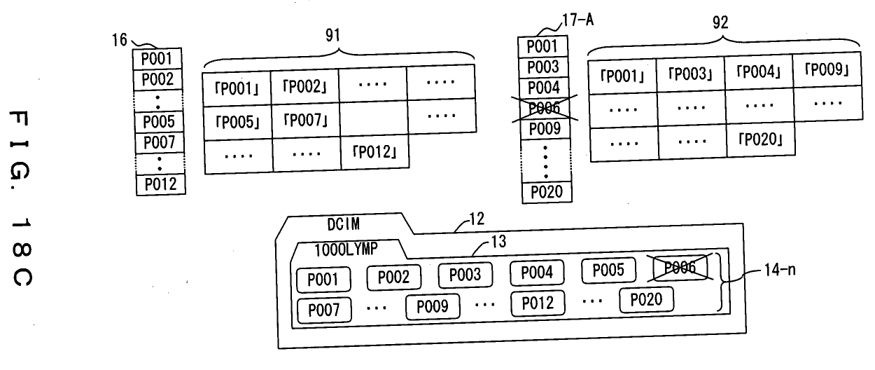

The method for deleting the image data file 14-n stored in the image root folder 12 of the memory card 11 is explained below by referring to FIGS. 18A, 18B, and 18C.

FIGS. 18A, 18B, and 18C show the data contents of the album list file 15 and the storage status of the image data file 14-n in the image root folder 12, which are stored in the memory card 11, and show the schematic charts of the display screen when the taken image of the album image are displayed on the display unit 28 in the storage status.

In each of FIGS. 18A, 18B, and 18C, in the contents of the data of the album list file 15, the shooting list 16 shows the contents as is, and the album list 17 shows a list of an album “ALBUM 1” with the reference numeral “17-A”. A taken image listing display 91 shows a listing screen of taken images displayed on the display unit 28 based on the contents of the list of the shooting list 16. The image listing display 92 of the image of “ALBUM A” indicates the listing screen of an album image displayed on the display unit 28 based on the contents of the list of album list 17-A of the “ALBUM A” at that time.

In this example, the camera 10 has nothing other than the “ALBUM A”.

FIG. 18A shows an example of the storage status before the image data file 14-n is deleted.

In the example shown in FIG. 18A, the sequence of the file names of the image data file 14-n shown in the shooting list 16 is “P001, P002, . . . , P005, P006, P007, . . . , P012”. In this case, the taken image listing display 91 is a listing of images indicated in the image data file 14-n with the file names assigned. In this example, the sequence of the file names of the image data file 14-n indicated in the album list 17-A of “ALBUM A” is “P001, P003, P004, P006, P009, . . . , P020”. In this case, the image listing display 92 of the “ALBUM A” is a listing of images indicated by the image data file 14-n with the file names. At this time, the image storage folder 13 in the image root folder 12 stores the image data file 14-n having the file names “P001, P002, P003, P004, P005, P006, P007, . . . , P009, . . . , P012”.

In the status shown in FIG. 18A, at an instruction to delete the taken image of the “P006” by the user of the camera 10, the data manipulation is performed on the data in the memory card 11 as shown in FIG. 18B.

In the transition from FIG. 18A to FIG. 18B, the file name of “P006” is deleted from the shooting list 16. Therefore, the taken image of “P006” is deleted from the taken image listing display 91. However, in FIG. 18A, “P006” is also contained in the album list 17-A of “ALBUM A” as an album image. Therefore, the image data file 14-n is not deleted for “P006” from the image root folder 12. Therefore, at this time, the image of “P006” can be displayed, and the image of “P006” is actually displayed on the image listing display 92 of “ALBUM A”.

Then, in the status shown in FIG. 18B, at an instruction to delete the album image of the “P006” by the user of the camera 10, the data manipulation is performed on the data in the memory card 11 as shown in FIG. 18C.

In the transition from FIG. 18B to FIG. 18C, the file name of “P006” is deleted from the album list 17-A of “ALBUM A”. Therefore, at this time, the album image of “P006” is deleted from the image listing display 92 of “ALBUM A”. As a result, the file name of “P006” is not found in the shooting list 16 and the album list 17-A of “ALBUM A”. Therefore, in this case, the image data file 14-n for “P006” is deleted from the image root folder 12.

As described above, the image data file 14-n having a specific name is deleted only when the file name is not found in the list of each album shown in the shooting list 16 and the album list 17. Thus, the image data file 14-n can be appropriately deleted when the same images are stored in a plurality of lists.

The process of enabling the CPU 30 using the camera 10 to delete the image data file 14-n is explained below.

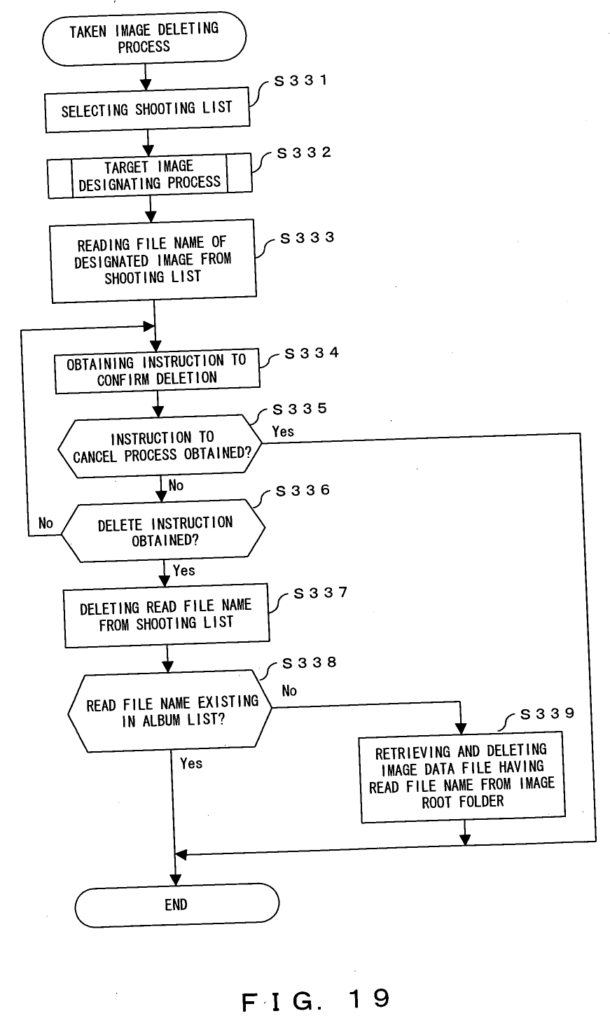

The process shown in FIG. 19 is explained first. FIG. 19 is a flowchart of the contents of the taken image deleting process. This process is to delete the file name of the taken image relating to the instruction from the shooting list 16 when the delete instruction of the taken image is obtained from a user, and to delete the image data file 14-n which is the file name from the image root folder 12 only when the file name is not indicated in the album list 17. That is, in this process, although the taken image related to the delete instruction obtained from a user is contained in an album as an album image, the image data file 14-n can be appropriately deleted.

This process is started when the delete instruction of a taken image is issued by operating the operation input unit 32 by a user.

First, in S331, the shooting list 16 is selected from the album list file 15 stored in the memory card 11. In S332, the above-mentioned target image designating process (FIG. 17) is performed and a taken image to be deleted is designated.

In S333, the file name of the designated taken image in the process in the previous step is read from the shooting list 16.

In S334, an instruction to confirm the deletion of a taken image in the operation of the operation input unit 32 by a user is obtained. In S335, it is determined whether or not the instruction is to cancel the deleting process. If the determination result is YES, the taken image deleting process is immediately terminated. If the determination result is NO, it is determined in S336 whether or not the instruction is to perform the deleting operation. If the determination result is YES, control is passed to S337. If the determination result is NO, control is returned to S334, and the above-mentioned processes are repeated.

In S337, the file name read in the process in S333 is deleted from the shooting list 16.

In S338, it is determined whether or not the file name read from the shooting list 16 is present in the process in S333 in the list of the file name of the image data file 14-n about each album in the album list 17 of the album list file 15. If the file name is present in the album list 17 (determination result is YES), then the taken image deleting process is terminated as is. On the other hand, if the file name is not present in the album list 17 (the determination result is NO), the image data file 14-n of the file name is retrieved from the image root folder 12 and deleted. Then, after the process in S339 is terminated, the taken image deleting process is terminated.

Described above is the taken image deleting process.

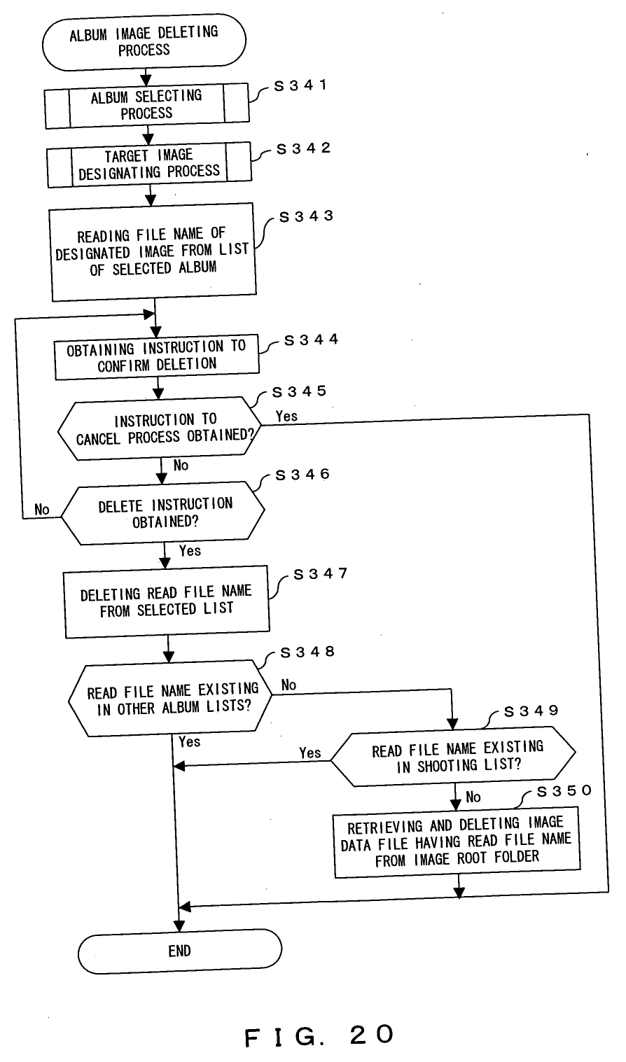

The flowchart shown in FIG. 20 is explained below. FIG. 20 is a flowchart of the contents of the album image deleting process. This process is to delete a file name about an album image related to the instruction from the album list 17 when a delete instruction of an album image is obtained from a user. And when the file name is not indicated in the shooting list 16 and the album list 17, the image data file 14-n which is the file name is deleted from the image root folder 12. That is, in this process, when the album image related to a delete instruction obtained from a user is a taken image or an album image contained in other albums, the image data file 14-n can be appropriately deleted.

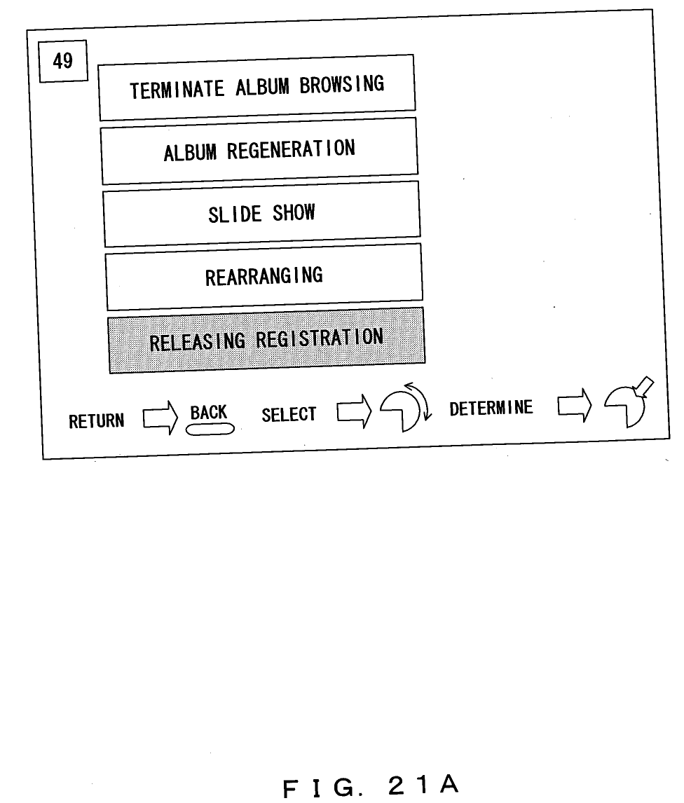

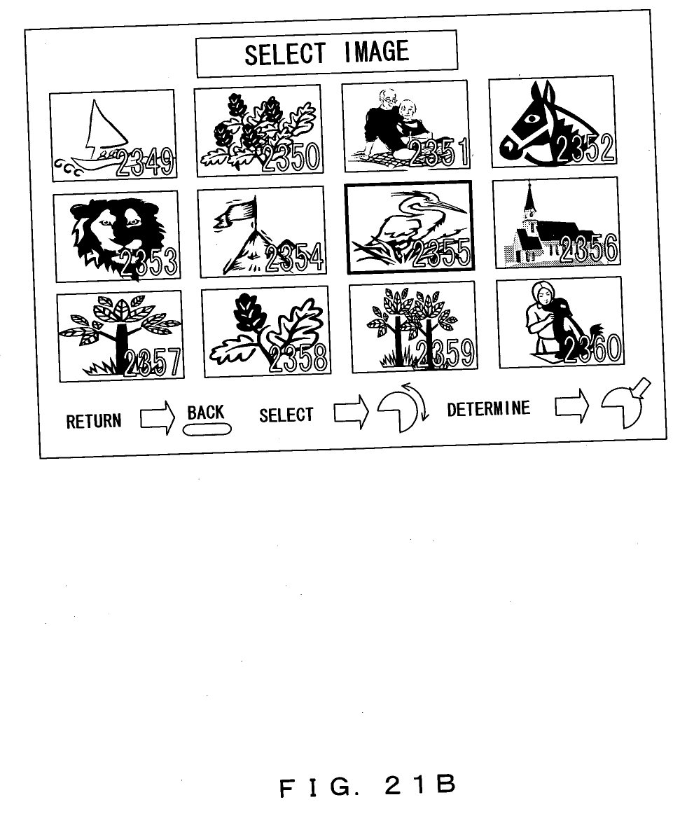

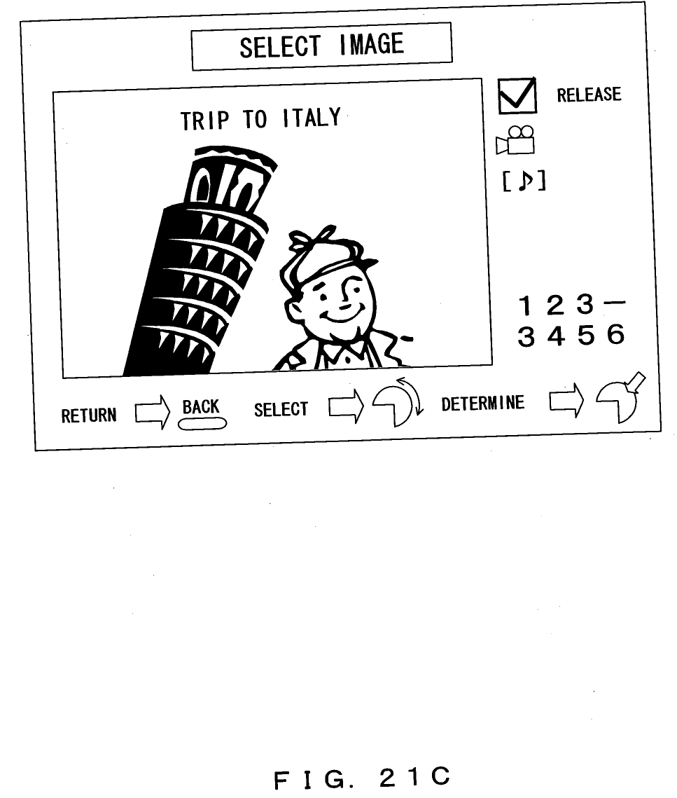

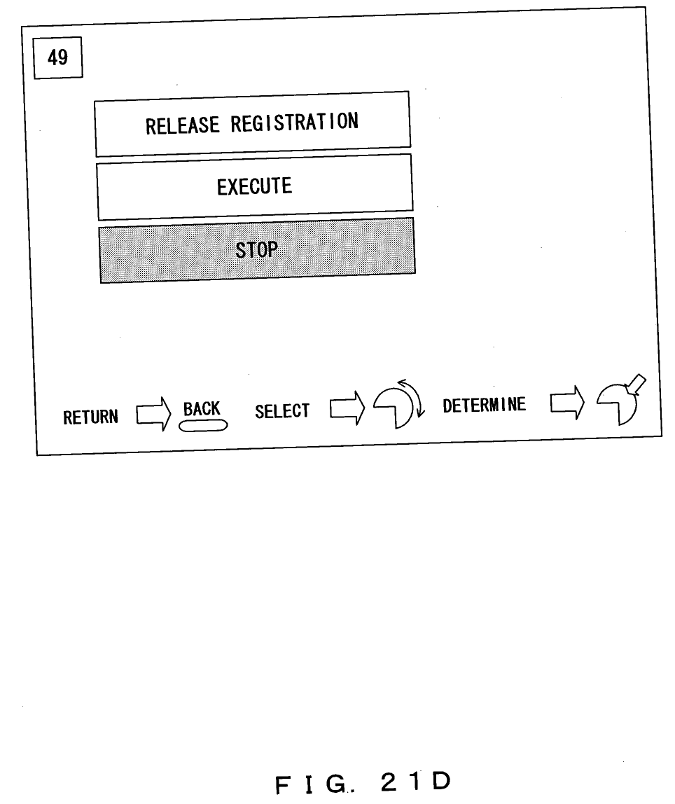

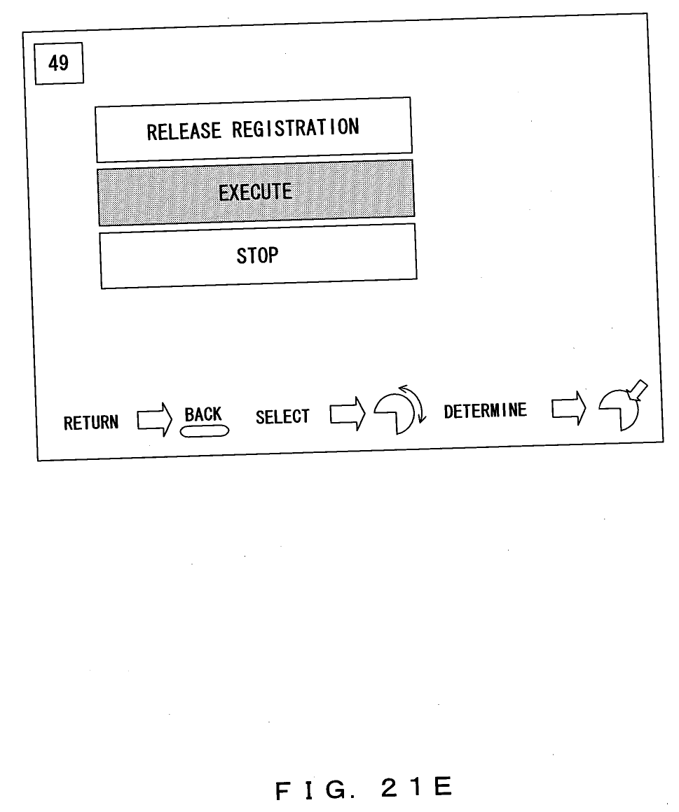

The album image deleting process is started when a user operates the operation input unit 32 and displays an album manipulation function selection screen on the display unit 28 as shown in FIG. 21A, and when the function of “releasing registration” is selected by the operation on the operation input unit 32.

First, in S341, the album selecting process (FIG. 15) is performed, and an album containing an album image to be deleted is selected.

Then, in S342, the target image designating process (FIG. 17) is performed and a taken image to be deleted is designated. In the process in S315 in the target image designating process, an example of the listing screen of album images displayed on the display unit 28 of the camera 10 is shown in FIG. 21B, and an example of the one-frame display screen of album images displayed on the display unit 28 in the process in S320 is shown in FIG. 21C.

In S343, the file name of the album image designated in the process in the previous step is read from the list of the album selected in the process in S341 in the album list 17.

In S344, an instruction of executing the deletion of an album image by a user operating the operation input unit 32 is obtained. In S345, it is determined whether or not the instruction indicates canceling the deleting process. If the determination result is YES, then the album image deleting process is terminated as is. If the determination result is NO, then in S346, it is determined whether or not the instruction indicates the execution of deletion. If the determination result is YES, control is passed to S347. If the determination result is NO, then control is returned to S344, and the above-mentioned processes are repeated.

Relating to the process in S344, to specify a cancel instruction on the album image deleting process, the screen displayed on the display unit 28 is shown in FIG. 21D, and the screen for displaying on the display unit 28 the delete instruction for an album image is shown in FIG. 21E.

In S347, the file name read in the process in S343 is deleted from the list of albums selected in the process in S341 in the album list 17.

In S348, it is determined whether or not there is a file name read from the album list 17 in the process in S343, and existing in the list of the file name of the image data file 14-n about each album in the album list 17. If there is any corresponding file name in the album list 17 (determination result is YES), then the album image deleting process is terminated as is. If the file name is not found in the album list 17 (determination result is NO), then control is passed to S349.

In S349, it is determined whether or not there is a file name read from the album list 17 in the process in S343 in the shooting list 16. If there is the file name (determination result is YES), then the album image deleting process is terminated as is. If the file name is not found in the shooting list 16 (determination result is NO), then the image data file 14-n of the file name is retrieved from the image root folder 12 in S350. When the process in S350 is completed, the album image deleting process is terminated.

Described above is the album image deleting process.

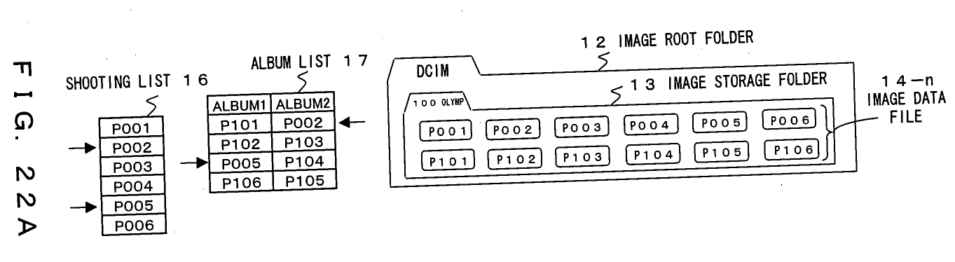

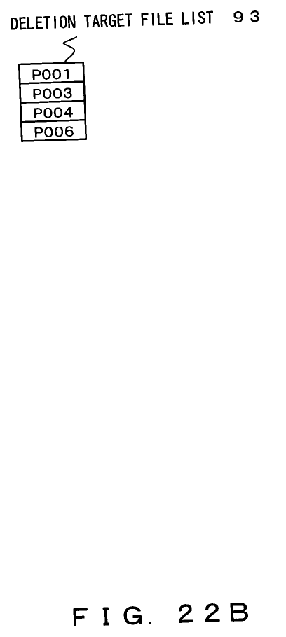

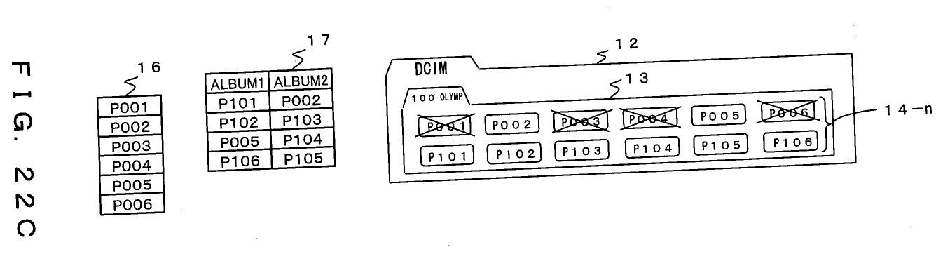

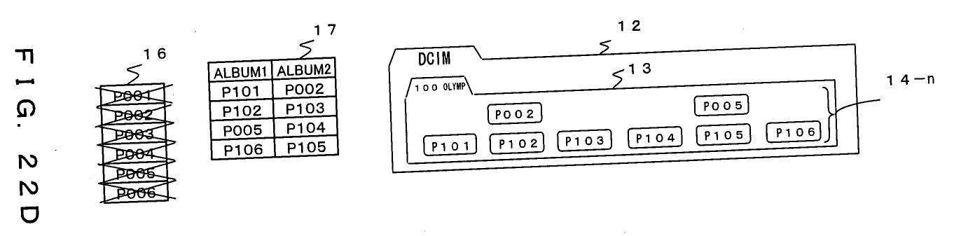

Then, the collective deletion of a taken image, that is, the method of collective deletion of the image data file 14-n whose file name is shown in the shooting list 16 in the album list file 15 is explained below by referring to FIGS. 22A, 22B, 22C, and 22D.

The example of data shown in FIG. 22A indicates the storage status of the memory card 11 before a collective deletion.

In the example shown in FIG. 22A, the sequence of file names of the image data file 14-n shown in shooting list 16 is “P001, P002, P003, P004, P005, P006”. In the album list 17, the file names of the image data file 14-n as a list of “ALBUM A” are “P101, P102, P005, P106”. Furthermore, as a list of “ALBUM 2”, the file names of the image data file 14-n are arranged as “P002, P103, P104, P105”. At this time, the image storage folder 13 in the image root folder 12 stores “P001, P002, P003, P004, P005, P006, P101, P102, P103, P104, P105, P106”.

In FIG. 22A, the “P002” and “P005” having the respective arrows in the shooting list 16 and album list 17 are indicated in the shooting list 16 and the album list 17. Therefore, the taken images of these file names are registered as album images.

In the status shown in FIG. 22A, a deletion target file list 93 shown in FIG. 22B is generated based on the instruction of the collective deletion of taken images from the user of the camera 10. The list is obtained by extracting what is not shown in the album list 17 in the file names shown in the shooting list 16. Practically, by comparing the shooting list 16 with the album list 17, the file names “P001, P003, P004, P006” indicated in the shooting list 16, but not shown in the album list 17 are arranged as a list generated as the deletion target file list 93.

Thus, FIG. 22C shows the status of collectively deleting the image data file 14-n whose file names are detected in the generated deletion target file list 93 from the image storage folder 13 in the image root folder 12 of the memory card 11. That is, in FIG. 22C, the image data file 14-n having the file names of “P001, P003, P004, P006” shown in the deletion target file list 93 in FIG. 22B is collectively deleted from the image storage folder 13.

FIG. 22D also shows the status of the collective deletion of file names shown in the shooting list 16 performed in synchronization with the collective deletion of the image data file 14-n based on the deletion target file list 93. That is, by collectively deleting all file names “P001, P002, P003, P004, P005, P006” from the shooting list 16 the taken image collective deletion can be completed.

As described above, at an instruction to collectively delete taken images, the file names shown in the shooting list 16 are compared with the file names indicated in the album list 17, the file names indicated by the shooting list 16 but not indicated by the album list 17 are extracted, and the information, that is, the deletion target file list 93, is generated, all image data files 14-n designated by the file names indicated by the 93 are deleted from the image root folder 12, and all file names indicated by the shooting list 16 are collectively deleted at the collective delete instruction, thereby appropriately performing collective deletion of the image data file 14-n when the same images are doubly registered as a taken image and an album image.

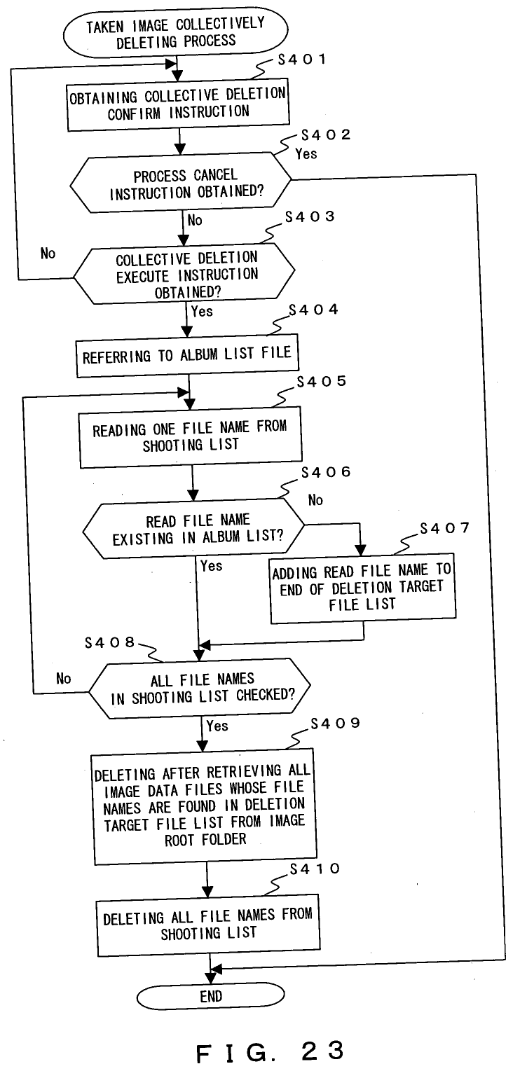

Described below is the taken image collectively deleting process which is to allow the CPU 30 to realize the method for collective deletion of taken images by the camera 10. FIG. 23 is a flowchart of the contents of the taken image collectively deleting process.

This process is started when an instruction for collective deletion of taken images is issued by operating the operation input unit 32 by a user.

First, in S401, an instruction to perform collective deletion of taken images by a user operating the operation input unit 32. In S402, it is determined whether or not the instruction is to cancel the collective deletion. If the determination result is YES, the collective image deletion process is immediately terminated. If the determination result is NO, then it is determined in S403 whether or not the instruction is to perform collective deletion. If the determination result is YES, control is passed to S404. If the determination result is NO, control is returned to S 401, and the above-mentioned processes are repeated.

In S404, the album list file 15 stored in the memory card 11 is referred to.

In S405, a file name is read one by one from the shooting list 16 in the album list file 15.

In S406, it is determined whether or not there is a file name read from the shooting list 16 in the process in S405 in the file name list of the image data file 14-n about each album in the album list 17 of the album list file 15. Only when there is no file name in the album list 17 (only when the determination result is NO), the file name is added to the end of the deletion target file list 93 in S407. Since the deletion target file list 93 is used only before the collective image deletion process is terminated, for example, it can be arranged in the record area of the RAM 25. If there is no deletion target file list 93 when the process in S407 is performed, it is newly generated.

In S408, it is determined whether or not each of all file names indicated by the shooting list 16 in the album list file 15 is found in the album list 17. If all file names are checked (determination result is YES), then control is passed to S409. If there are file names still unchecked (determination result is NO), control is returned to S405, and the file name is checked about the presence/absence in the album list 17.

In S409, the image data file 14-n whose file name is indicated in the deletion target file list 93 is detected from the 12, and deleted.

In S410, all file names of the image data file 14-n indicated by the shooting list 16 are deleted. Afterwards, the taken image collectively deleting process is terminated.

Described above is the taken image collectively deleting process.

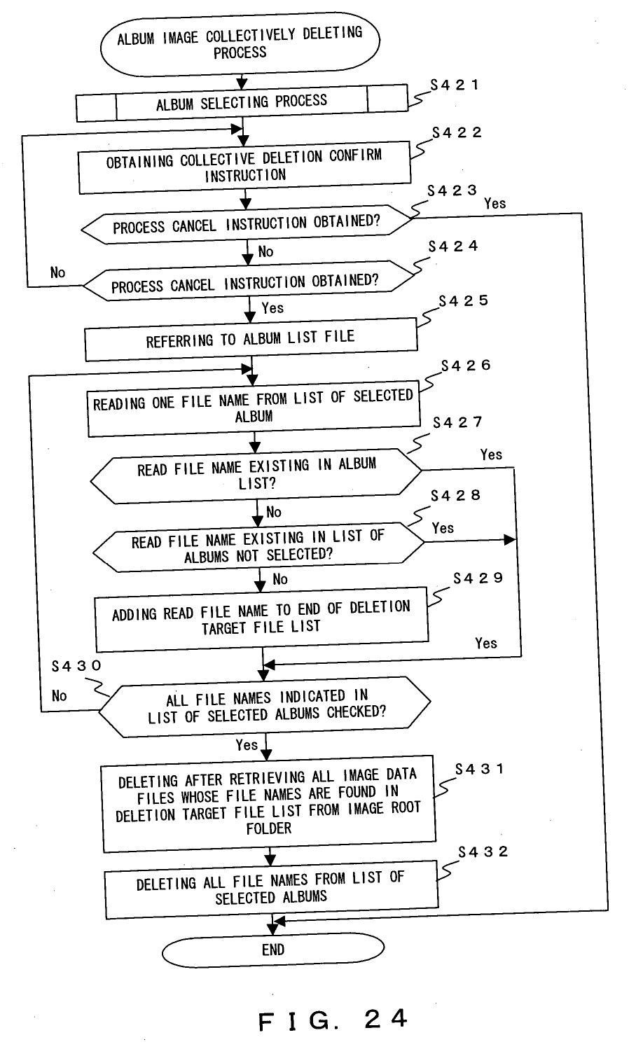

The flowchart shown in FIG. 24 is explained below. FIG. 24 is a flowchart of the contents of the album image collectively deleting process.

The above-mentioned taken image collectively deleting process is the process performed at a taken image collectively deleting process instruction from a user of the camera 10, but the album image collectively deleting process is performed when a user of the camera 10 issues an instruction of collective deletion of all album images contained in the specified album, and the image data file 14-n can be appropriate deleted collectively although the album image contained in a specified album is also contained in another album, or although an album image contained in a specified album is a taken image.

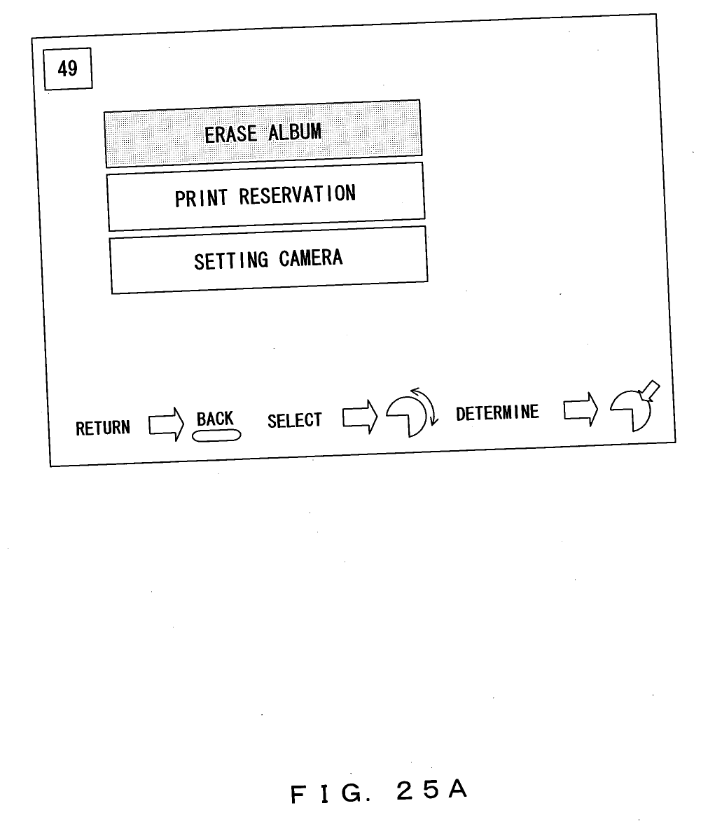

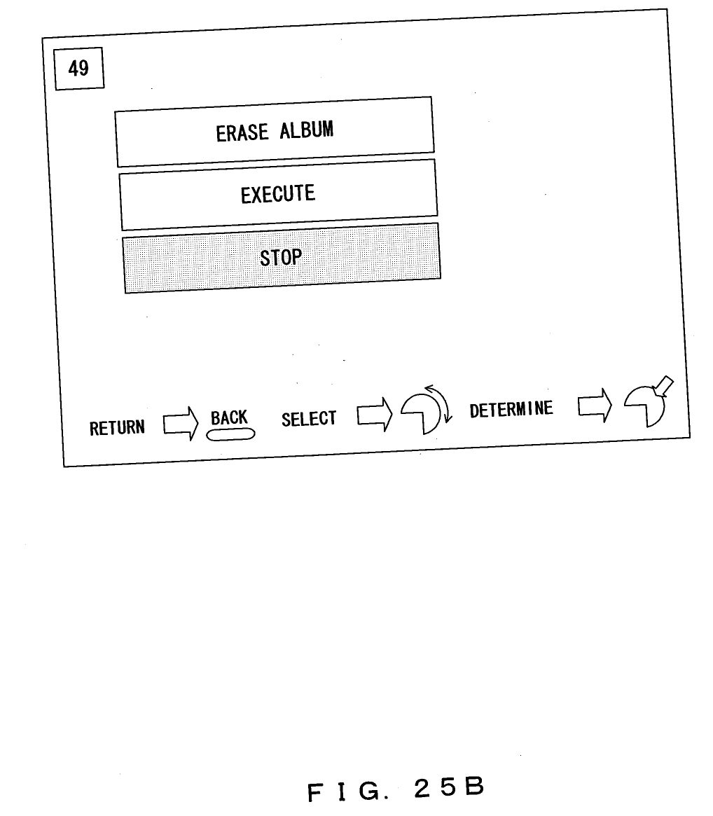

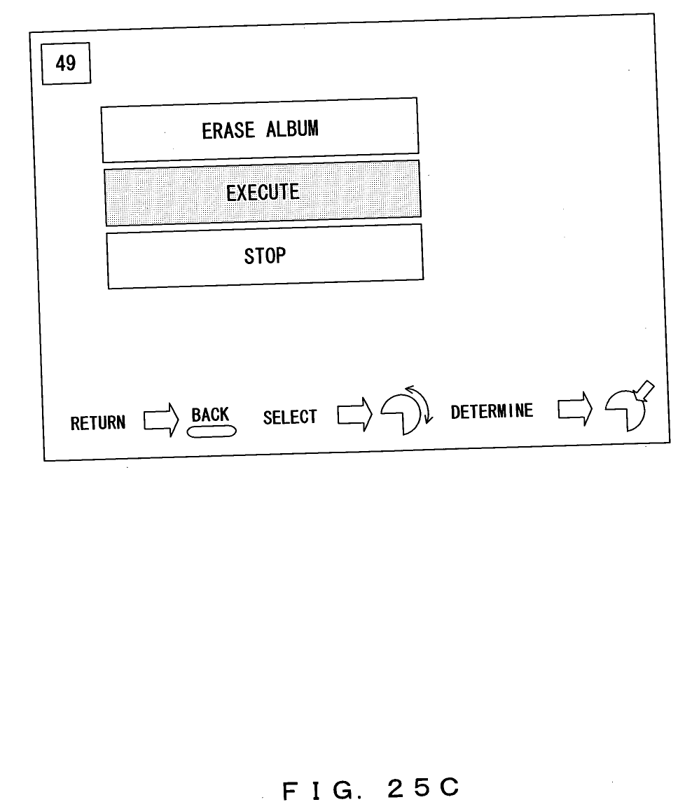

The album image collectively deleting process is started when a user operates the operation input unit 32 to display the function selection screen as illustrated in FIG. 25A on the display unit 28, and when the function of “erasing an album” is selected by the operation on the operation input unit 32.

First, in S421, the album selecting process (FIG. 15) is performed and the process of selecting an album containing the album image to be collectively deleted is performed.

Then, in S422, the user operates the operation input unit 32 to obtain an instruction to perform an album image collectively deleting process. In S423, it is determined whether or not the instruction refers to canceling the collective image deletion process. If the determination result is YES, the album image collectively deleting process is immediately terminated. On the other hand, if the determination result is NO, it is determined in S424 whether or not the instruction refers to performing the collective deletion. If the determination result is YES, control is passed to S425. If it is NO, control is returned to S422, and the above-mentioned processes are repeated.

Relating to the process in S422, the screen to be displayed on the display unit 28 to specify canceling the album image collectively deleting process is shown in FIG. 25B, and FIG. 25C shows the screen to be displayed on the display unit 28 to specify performing the album image collectively deleting process.

In S425, the album list file 15 stored in the memory card 11 is referred to.

In S426, one file name is read from the list about the album selected by the process in S421 in the album list 17 of the album list file 15.

In S427, it is determined there is a file name read in the process in S426 in the list of the file names of the image data file 14-n in the shooting list 16 of the album list file 15. If there is the file name in the list (if the determination result is YES), control is passed to S430.

On the other hand, in the determining process in S427, if there is no corresponding file name in the shooting list 16 (determination result is NO), then it is determined in S428 whether or not there is a file name read in the process in S426 in the list of the album other than those selected in the process in S421 in the album list 17 of the album list file 15. If the file name is contained in the list (determination result is YES), then control is passed to S430.

If the file name is not contained in the list about other albums (the determination result is NO) in the determining process in S428, then the file name is added to the end of the deletion target file list 93. Since the deletion target file list 93 is used until the album image collectively deleting process is completed, it can be arranged in the record area of the RAM 25. When there is no deletion target file list 93 during the process in S429, it is newly generated.

In S430, it is determined whether or not the presence/absence of all file names indicated in the list of the album selected in the process S421 in the album list 17 of the album list file 15 has been checked in the shooting list 16 and the album list 17. If all file names are checked (determination result is YES), control is passed to S431. If all file names have not been checked (determination result is NO), then control is returned to S426, and the process of checking the presence/absence of the file name in other lists is repeated.

In S431, the image data file 14-n indicating file names in the deletion target file list 93 is retrieved from the image root folder 12 and deleted.

In S432, the file names of the image data file 14-n in the list of the album selected in the process in S421 in the album list 17 of the album list file 15 are all deleted from the list, thereby terminating the album image collectively deleting process.

Described above is the album image collectively deleting process.

In the embodiments above, the album image deleting process shown in FIG. 20 and the album image collectively deleting process shown in FIG. 24 are performed by the CPU 30 of the camera 10. However, when the PC 40 adopts the management of an image data file using an image list file to provide an album function, these processes can be performed by each of the CPU 51 of the PC 40 to appropriately delete images or perform collective deletion of the images when the same images are contained in a plurality of albums.

The present invention is not limited to the above-mentioned embodiments, and can further be applied to variations and improvements of the embodiments within the gist of the present invention.

1. An image management apparatus, comprising:
a dependence information file generation unit generating a dependence information file indicating dependence between an image data file and a group to which the image data file belongs;
an image data file selection unit selecting an image data file;
an information input unit inputting related information to be displayed with a reproduced image when the selected image data file is reproduced;
an image data file generation unit generating an image data file with related information for use in reproducing the related information together with the selected image data file; and
a group selection unit selecting a group to which the image data file with related information belongs, wherein
the dependence information file generation unit generates image designation information for designation of the dependence between the image data file with related information and the selected group, and the image designation information is stored in the dependence information file such that the image data file with related information can be reproduced in a predetermined order.

2. The apparatus according to claim 1, further comprising:
a file group selection unit selecting a file group of the image data files which stores at least one image data file;
an image data file selection unit selecting an image data file for association with a selected file group;
an information input unit inputting related information for reproduction and display with the selected image data file;
a representative image generation unit generating a representative image data file to combine the related information and the selected image data file;
an association unit associating the generated representative image data file with the selected file group, and regulating a reproduction priority for use in reproducing the selected file group.

3. The apparatus according to claim 2, wherein
the image data file selection unit comprises a reproduction and display unit for reproducing and displaying an image data file stored in a file group selected by the file group selection unit, and selecting a file from among the reproduced and displayed image data files.

4. The apparatus according to claim 3, wherein
the representative image data file is first reproduced as a cover when the selected file group is reproduced.

5. The apparatus according to claim 2, wherein:
the file group configures an album storing a group of images represented by image data files stored in the file group; and
the representative image data file configures a cover of the album which is the selected file group.

6. An image managing method, comprising:
obtaining an instruction to select a file group of the image data files which stores at least one image data file;
obtaining an instruction to select an image data file for association with the selected file group;
obtaining the input of the related information for reproduction and display with the selected image data file;
generating a representative image data file to combine the related information and the selected image data file together; and
associating the generated representative image data file with the selected file group, and regulating the reproduction priority in reproducing the selected file group.

7. A computer-readable record medium storing a program used to direct a computer to manage an image to perform the processes, comprising:
obtaining an instruction to select a file group of the image data files which stores at least one image data file;
obtaining an instruction to select an image data file for association with the selected file group;
obtaining the input of the related information for reproduction and display with the selected image data file;
generating a representative image data file to combine the related information and the selected image data file together;
associating the generated representative image data file with the selected file group, and regulating the reproduction priority in reproducing the selected file group.

8. An image display apparatus, comprising:
an image data file storage unit storing a representative image data file which is generated by combining an image data file and related information for reproduction and display with the image data file and for which a reproduction priority for use in reproduction and display is regulated;
a file group selection unit selecting a file group to be reproduced and displayed from a file group including at least one image data file; and
a reproduction and display unit reproducing and displaying a representative image data file associated with the selected file group in the reproduction priority.

9. An image management apparatus, comprising:
a record unit storing a plurality of image data files;
a dependence information storage unit storing dependence information indicating the dependence between an image data file recorded in the record unit and a group to which the image data file belongs;
a dependence dismissal unit dismissing the dependence indicated by designated dependence information by changing the dependence information relating to predetermined image data file described in the designate dependence information in the dependence information storage unit when there is an instruction to delete a predetermined image data file belonging to a predetermined group; and
a data file deletion unit deleting the predetermined image data file from the record unit when the dependence between the predetermined image data file and any group is dismissed by the dependence dismissal unit.

10. The apparatus according to claim 9, wherein
the image management apparatus is a camera.

11. The apparatus according to claim 10, wherein:
the predetermined group is configured by an image data file recorded on the record unit provided for the camera by a shooting operation by the camera; and
the delete instruction is to delete an image data file obtained by the camera from the record unit.

12. The apparatus according to claim 9, wherein
the group configures an album storing a group of images represented by an image data file belonging to the group; and
the delete instruction is to delete an image data file of images contained in the album specified in the album from the predetermined album.

13. An image managing method, comprising:
dismissing a dependence, which is indicated by designated dependence information, by changing the dependence information, which indicates the dependence between image data files recorded in a record unit and a group to which each of the image data files belongs, and which relates to a predetermined image data file when there is an instruction to delete the predetermined group; and
deleting the predetermined image data file from the record unit when the dependence between the predetermined image data file and any group is dismissed.

14. An image management apparatus, comprising:
a dependence information storage unit storing dependence information indicating the dependence between an image data file and a group to which the image data file belongs;
a deletion target file information generation unit comparing specified dependence information indicating the dependence information about a specified group in the dependence information stored in the dependence information storage unit with other dependence information and generating deletion target file information which is the information designating an image data file not belonging to a group other than the specified group in the image data files belonging to the specified group when an instruction to collectively delete image data files belonging to the specified group is received;
an image data file deletion unit deleting all image data files designated by the generated deletion target file information from a record unit recording the image data file; and
a dependence dismissal unit dismissing all dependence about the specified group indicated by the specified dependence information by changing the dependence information when the instruction to collectively delete the image data files is received.

15. The apparatus according to claim 14, wherein
the image management apparatus is a camera.

16. The apparatus according to claim 15, wherein:
the predetermined group is configured by an image data file recorded on the record unit provided for the camera by a shooting operation by the camera; and
the collectively delete instruction is to collectively delete an image data file obtained by the camera from the record unit.

17. The apparatus according to claim 14, wherein
the group configures an album storing a group of images represented by an image data file belonging to the group; and
the collectively delete instruction is to collectively delete an image data file of all images contained in the album specified in the album from the predetermined album.

18. An image managing method, comprising:
comparing specified dependence information indicating a dependence information about a specified group in the dependence information, which indicates the dependence between an image data file and a group to which the image data file belongs, with other dependence information when an instruction to collectively delete image data files belonging to the specified group is received, and generating deletion target file information designating an image data file not belonging to a group other than the specified group in the image data files belonging to the specified group;
deleting all image data files designated by the generated deletion target file information from a record unit recording the image data file; and
dismissing all dependence about the specified group indicated by the specified dependence information by changing the dependence information when the instruction to collectively delete image data files is received.

19. An image management apparatus, comprising:
image memory storing a plurality of image data files;
a first control file describing dependence information for a first image data file selected from the image memory;
a second control file describing dependence information for a second image data file selected from the image memory;
an image data file deletion unit designating a control data file commonly registered in the first and the second control file when an instruction to collectively delete the contents of the first control file is issued, and further designating a control data file other than the designated common control data file from the first control file, and deleting an image data file corresponding to the designated control data file from the image memory; and
a control data file deletion unit collectively deleting all control data files stored in the first control file when the instruction to collectively delete the contents of the first control file is issued.
